(19) United States
(12) Patent Application Publication
(10) Pub. No.: US 2005/0144194 A1
(43) Pub. Date: Jun. 30, 2005

(54) Object storage

(76) Inventor: Fernando Gracia Lopez, Garza Garcia (MX)

Correspondence Address: FISH & RICHARDSON P.C., 5000 BANK ONE CENTER, 1717 MAIN STREET, DALLAS, TX, 75201, US

(21) Appl. No.: 10/881,113

(22) Filed: Jun. 30, 2004

Related U.S. Application Data
(60) Provisional application No. 60/532,354, filed on Dec. 24, 2003.

(51) Int. Cl. G06F 17/00

(52) U.S. Cl. 707/104.1

(57) ABSTRACT

An automated, multi-tiered system and process for storing objects includes the ability to efficiently store and retrieve objects. The system may include a number of object entrance ports, object exit ports, elevators, horizontal transportation systems, and storage levels, each storage level including a number storage bays. The horizontal transportation systems may move objects after they have been mounted on frames. The movements of an object entering and departing the multi-tiered system may be based on ordered, anticipated tasks, for the purpose of enhancing the system layout and operation.

### CROSS-REFERENCE TO RELATED APPLICATIONS

This application claims the benefit of and incorporates by reference U.S. Provisional Application No. 60/532,354, filed Dec. 24, 2003, and entitled “Object Storage System.”

### FIELD OF THE INVENTION

This invention relates to object storage, and, more particularly, to systems and processes for object storage.

### BACKGROUND

As large cities have continued to become more and more crowded, the need for space conserving techniques has grown. One technique that has shown promise is automated parking garages. By eliminating the maneuvering lanes required when driving automobiles, such garages offer substantial space savings over traditional parking garages. Automated parking garages may also offer advantages in reducing toxic gases (e.g., automobile emissions) and in vehicle safety.

Automated parking garages typically include entrance ports, storage pallets, elevators, conveyors, storage bays, and exits ports, housed in a multi-level structure. The structure may be above ground, partially above and partially below ground, or below ground. The number of levels and storage bays in these installations are generally configured to solve the general problem of providing more parking per structure volume. For a more complete solution, a design may also address safety, reliability, storage time, and/or retrieval time.

### SUMMARY

The invention addresses the concept of organizing the multiple facets of an object storage system to achieve efficient operation. Efficiency may be measured in terms of object storage and retrieval times, space distribution of storage bays in relation to the number of elevators, and/or the ratio of the number of storage bays to the storage system volume. This may allow high structural integrity to be maintained at lower system operational costs and less demanding performance on the mechanisms and components therein.

In particular implementations, the invention provides for rapid and simultaneous multi-tasking operations, space efficiency, and mechanical reliability in an object storage system. In accomplishing this, a computer may be coupled to a data gathering network, which gathers and reports information regarding a number of power-driven transportation and utility systems and a number of elevators. The computer may supervise and control the movements and activities of the system and operate according to a set of instructions encoded in a machine-readable medium.

Object storage systems may include a multi-tiered structure, wherein the structure is adapted with a number of entrance and exit ports and a number of storage bays, with an efficient bay distribution grid-layout. The systems may provide for the reception of vehicles, containers mounted on wheels, and/or containers with appropriate understructures.

A transfer carriage system on each object storage level may be used to receive an object from an elevator, move the object between the elevator and at least some of an object storage level's storage bays, and horizontally deposit the objects in the storage bays.

For vehicles and wheeled containers, provisions may be made for mounting these objects on frames for ease of transportation by the transportation systems and elevators within the object storage system. Upon object retrieval, the frames are removed, and the object is delivered to an exit port. The frames may be operable to be mounted independently of each other to an object and to support the object and facilitate its movement in an object storage system. In certain implementations, the frames are operable to expand to receive wheels on a first object axis and to contract to engage the wheels on the axis. Additionally, an object transportation frame may include rollers that allow the frame to move along two axes. Provisions may also be made for similarly storing objects with integrated understructures including components similar to the frames.

An elevator may include a first drive system operable to engage an object and move it along a first axis and a second drive system operable to engage an object and move it along a second axis. The object may be unloaded along either the first axis or the second axis on an object storage level.

An elevator may also include an object support platform to receive an object. The object support platform may be operable to couple to a shaft of the elevator while receiving an object. If the elevator includes a cage, the cage may be operable to be decoupled from the object support platform while receiving an object.

Certain implementations may include a number of elevators wherein more than one of the elevators may be used for moving an incoming object to an object storage level and/or more than one of the elevators may be used for moving a departing object to an object release port. The computer may determine which elevator to use. Also, each object storage level may include a number of transfer carriage systems. An object may be moved across an elevator shaft, by, for example, exchanging it between adjacent transfer carriage systems.

An object storage system may also include a horizontal transportation system for moving a frame mounted object between an object receiving port and an elevator. The horizontal transportation system may include a guide set for each object transportation frame of a frame mounted object. Each guide set may include a plurality of guides, wherein an object transportation frame may be conveyed on different guides in a guide set depending on the size of the mounted object.

A horizontal transportation system may include a subsystem for moving an object along one axis and a subsystem for moving an object along another axis. A horizontal transportation system may also include an axis transfer subsystem operable to transfer the object between the axial transportation subsystems. The horizontal transportation system may be operable to center an object for at least one of the axial transportation systems based on the outer dimensions of the object.

An object storage system may additionally include an object mounting system operable to mount an object on an object transportation frame. A system may further include a frame recycling system operable to receive frames at an object release port and to convey them to the object mounting system. Such a system may stack the frames after they have been used, store them, and feed them so that they can be reused on another object.

Certain object storage systems may also include an object measuring system to measure the object, and/or an object aligning system to align the longitudinal centerline of the object. Some systems may include an object orientation system located between the object receiving port and the elevator.

Particular systems may include a horizontal transportation system for moving a frame mounted object if an object release port is occupied and a second port to release departing objects, the second port operable to receive an object from the horizontal transportation system if the first object release port is occupied.

In performing its functions, the computer may determine that an object in a multi-level object storage system is to be moved and determine a route for moving the object based on object storage system movements already in progress. For example, the computer may detect a signal indicating that an object has been received and determine a route to a storage bay for the object. As another example, the computer may detect a signal indicating that a stored object has been requested, determine the location of the stored object, and determine a route to an object release port for the stored object. As an additional example, the computer may determine that a container being stored in a storage bay of a multi-level object storage system has been requested and determine a route from the storage bay to an object access location. Determining a route may also be based on system movements waiting to commence and may include selecting one of a plurality of elevators for the route. The computer may also determine how to orient an object for an object release port.

The computer may be coupled to an object entrance port, an object mounting system, an object orientation system, a horizontal transportation system, an elevator, a transfer carriage system, a storage bay, and/or an object release port to manage the system. Management may include supervising and/or controlling the reception, transportation, storage, and release of objects in the object storage system by controlling the operations of these subsystems. In certain implementations, an object entrance port may also be an object exit port.

The computer may be operable to optimize one or more criteria in managing the object storage system. Criteria may include storage time for an object, occupancy density for the storage bays, and/or expended power.

In particular implementations, an object storage system may provide for administrative processing and controlled-mechanical loading and unloading of objects. Further, a system may provide for the simultaneous and multi-task routing assignment and control for rapid three-dimensional transportation of objects from the entrance ports to the storage bays. A system may also provide for the simultaneous and multi-task routing assignment and control for the rapid three-dimensional transportation of objects from the storage bays to the exit ports.

In certain implementations, the entrance port provides a reception area for object measurement (e.g., weight and dimension) and verifying object acceptance into the system in accordance with specifications. Also, the reception area may generate a receipt for the object custodian. Likewise, the storage system may have an administrative system for processing a request to retrieve a stored object. The administrative system may be able to identify an object for retrieval and determine whether administrative requirements have been satisfied.

In particular implementations, efficient physical layout of storage bays includes locating them in the immediate surrounding tier-area of each elevator so that each storage bay has direct access to at least one elevator. The storage bays may also have access to other elevators.

Various implementations of the invention have particular features and benefits. For example, in certain implementations, the storage and retrieval times are reduced and the utilization of system space is increased. This may be accomplished, in part, by multi-tasking activities of organizing the entry and exit of objects and the movement routing sequences. These multi-tasking activities may be determined by a computer and executed contemporaneously thereby. Once the computer defines an efficient path in routing the objects from an entry port to a storage bay or from a storage bay to an exit port, the routing time is reduced by taking advantage of rapid ascension and descension elevators and rapid displacement of one or more horizontal transportation systems. Because the elevators and horizontal transportation systems may operate independently of each other, little time is wasted while waiting for another system to deliver an object.

As another example, in particular implementations, routing sequence motions are registered, and failures are easily detected. Additionally, if necessary, alternate mechanisms and/or sensors are substituted, and routing sequences may be modified, enabling the system to continue operating. Thus, risk of operational discontinuities emanating from human intervention and mechanical failures are reduced by early detection and evaluation, and the issuance of protective measures by the centralized computer.

As another example, in certain implementations, an enhancement is achieved between the aspects of storage and retrieval times, available system volume, and number of storage bays. In effect, the ratio of number of objects stored versus available storage volume is increased, and the storage and retrieval times are decreased.

Safety may also be enhanced by the incorporation of measures to avoid collisions, delinquency, buildup of toxic gases, rain, electrical discharges, and fires.

The invention is thought to be useful for a number of applications, including hospitals, airports, universities, high-density urban areas, shopping or commercial centers, and the like.

The details of one or more implementations are set forth in the accompanying drawings and the description below. Other features will be apparent from the description and drawings, and from the claims.

### BRIEF DESCRIPTION OF THE DRAWINGS

FIGS. 1A-D illustrate an example object storage system.

FIG. 2 illustrates a more detailed view of object receipt by the object storage system in FIGS. 1A-D.

FIGS. 3A-E illustrate an example object aligning system.

FIGS. 4A-K illustrate an example object transportation frame.

FIGS. 5A-M illustrate an example object mounting system.

FIGS. 6A-B illustrate a system for transferring a mounted object between two transportation systems.

FIGS. 7A-E illustrate an example elevator.

FIG. 8 illustrates an example transfer carriage system.

FIGS. 9A-C illustrate an example object dismounting system.

FIGS. 10A-E illustrate an example object transportation frame recycling system.

FIGS. 11A-H illustrate another example object storage system.

FIGS. 12A-D illustrates is a flow chart for a process for object storage.

FIG. 13 illustrates an example network of control components for an object storage system.

FIG. 14 illustrates an example computer.

FIG. 15 illustrates another example object storage system.

FIG. 16 illustrates another example object storage system.

FIG. 17 illustrates another example object storage system.

FIG. 18 illustrates another example object storage system.

FIG. 19 illustrates another example object storage system.

FIG. 20 illustrates another example object storage system.

FIG. 21 illustrates another example object storage system.

FIGS. 22A-B illustrate an object transportation frame for the object storage system of FIG. 21.

### DETAILED DESCRIPTION

An object storage system may include an object entrance port, a horizontal object transportation system, a vertical object transportation system, object storage bays, and an object exit port. The object entrance port, horizontal object transportation system, vertical object transportation system, object storage bays, and object exit port may be automatically controlled by a computer to harmonize operations therebetween. Other object storage systems, however, may include fewer or additional components and/or may be controlled by different techniques.

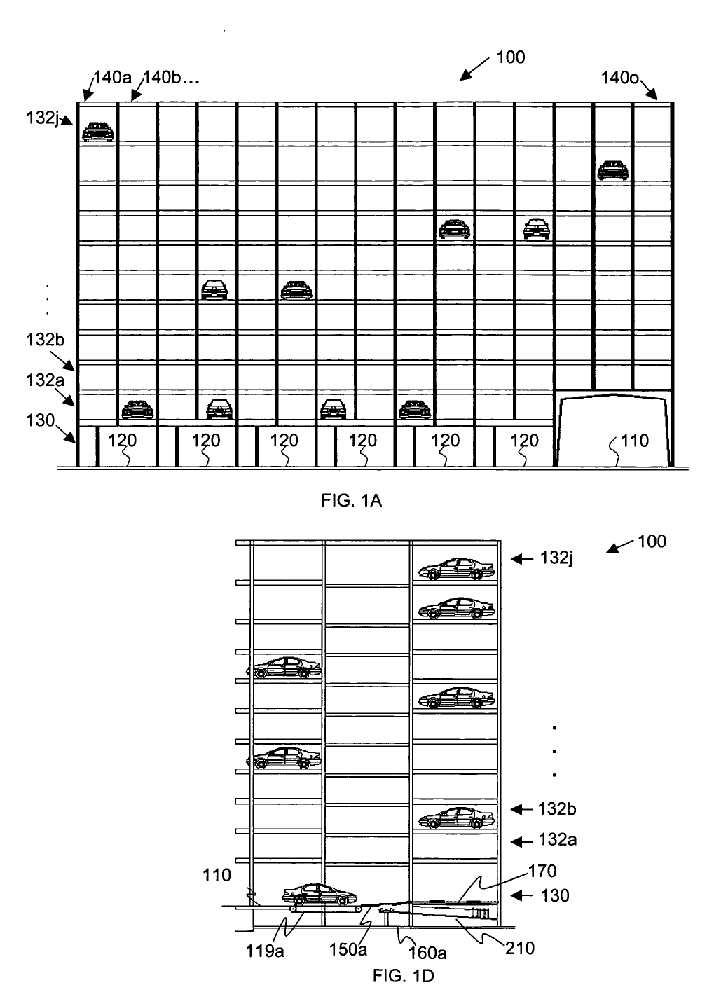

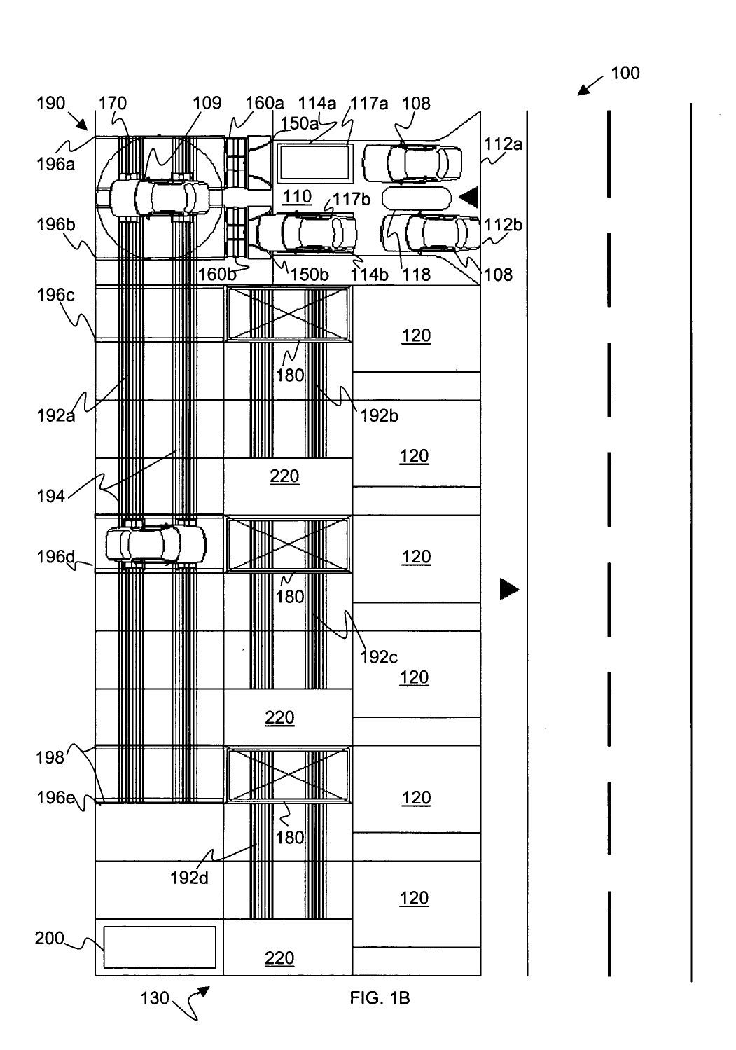

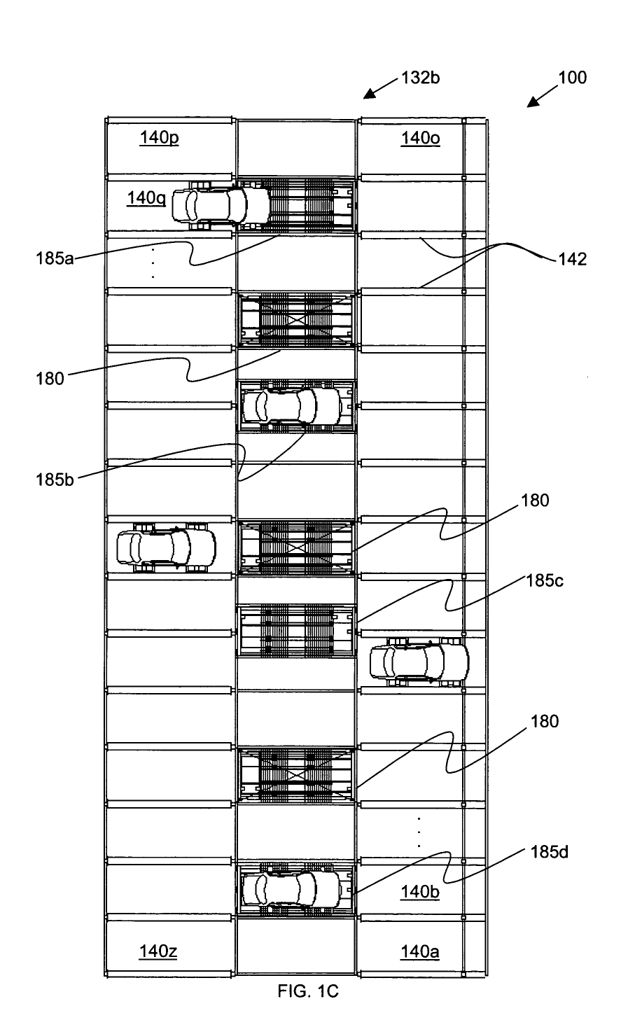

FIGS. 1A-D illustrate an example object storage system 100. FIG. 1A shows a front view of object storage system 100. As illustrated, object storage system 100 includes a first level 130 and a number of object storage levels 132. FIG. 1B shows a top view of first level 130, and FIG. 1C shows a top view of storage level 132b. FIG. 1D shows a side view of the object storage system.

In general, object storage system 100 may store any appropriate type of transportation object. But the capabilities and features of the object storage system will be illustrated by discussing its components and functions in the context of storing vehicles. It will be understood, however, that an object may be any type of vehicle, wheeled container, truck-mounted container, maritime container, or other appropriate transportation object. Furthermore, in particular implementations, an object storage system may be specially adapted to store a specific type of object (e.g., automobile, truck, shipping container, etc.).

As shown in FIG. 1A, object storage system 100 includes an object entrance port 110 and a number of object exit ports 120 on first level 130. In general, an object may exit object storage system 100 through any of object exit ports 120. The object storage system also includes a number of storage levels 132, each storage level 132 including a number of storage bays 140, the layout of which can be seen more clearly in FIG. 1C. Storage levels 132 do not have to be the same height. Thus, some levels may store shorter objects and some levels may store taller objects.

FIG. 1B provides a more detailed view of first level 130. In general, first level 130 is at street level, but in particular implementations, first level 130 may be above or below street level.

Object storage system 100 may be viewed as having an orthogonal coordinate system in which the longitudinal, or y, direction is defined along the entrance direction and the lateral, or x, direction is defined along the street direction. This coordinate system will be used to describe the object storage system. Other appropriate coordinate system could also be defined and used.

As can be seen, object entrance port 110 includes two lanes 112 for receiving objects 108, which are vehicles in the illustrated example. Object entrance port 110 also includes platforms 114 that each include an object measuring system 117 and an object reception system 118, which will be discussed in more detail below. An object identification function may be performed based on the date of object arrival, the time of object arrival, the object entrance port at arrival, the license plate number of the object, a picture of the object, and/or any other appropriate object identification information. The position of the object at various points in the object storage system may be associated with this information so that the object may be readily located. Object entrance port 110 additionally includes object moving systems 119, one of which can be seen in FIG. 1D, for moving the object into the object storage system for further processing.

First level 130 also includes object aligning systems 150, object mounting systems 160, and an object orientation system 170. Object aligning systems 150 align objects for object mounting systems 160, which mount objects on frames for transportation and storage in the object storage system. An object mounted on one or more frames will be identified as a mounted object 109. In particular implementations, one frame is used for one end of an object and one frame is used for another end of the object. Example frames will be discussed in more detail below. Object orientation system 170 orients the object so that it will have proper orientation upon exiting the object storage system. For a vehicle, it is typically desired that it exit in a forward orientation. Other orientations may be used, however, especially for other objects.

First level 130 additionally includes a number of elevators 180 and a horizontal transportation system 190. Horizontal transportation system 190 moves mounted object 109 from object orientation system 170 to one of elevators 180. Horizontal transportation system 190, which may or may not have one or more inclines at various points, includes a lateral transportation system 192a and a number of longitudinal transportation systems 196. Lateral transportation system 192a includes two guide sets 194 upon which mounted object 109 may move laterally—to position it in front of elevators 180, for example. A guide may be a rail, a bar, a track, a groove, or any other appropriate device for directing motion of an object. The guides in guide sets 194 may have a centerline-to-centerline spacing of between approximately two centimeters and four centimeters. Any of a variety of drive systems may be used to move the mounted object on guide sets 194. In certain implementations, sprockets are interspersed between the guides to provide the movement. Each of longitudinal transportation systems 196 includes a pair of guides 198 to move a mounted object into one of elevators 180. Any of a variety of drive systems may be used to move the mounted object on guides 198. In some implementations, each of guides 198 has a number of associated sprockets to provide the movement. Elevators 180 move the mounted object to the selected one of storage levels 132a-132j. The horizontal transportation system also includes lateral transportation systems 192b-d, which may laterally move a mounted object out of the elevators. Elevators 180 and horizontal transportation system 190 will be discussed in more detail below.

First level 130 also includes rooms 220. Rooms 220 may contain ergonomic appendages for the comfort of custodians delivering and/or retrieving objects. Rooms 220 may also house personnel for managing and operating the object storage system. In certain implementations, rooms 220 may allow access to an object that has been retrieved from storage.

First level 130 additionally includes a computer 200. Computer 200 is responsible for controlling the operations of various systems and components in object storage system 100. Computer 200 may be at a centralized location or may be distributed at multiple locations in the object storage system.

Computer 200 may be coupled to the systems and components for data exchange using any appropriate wireline technique and/or wireless technique. Wireline techniques may, for example, include dedicated couplings to one or more devices and/or shared couplings between two or more devices. Data could be exchanged by the use of any appropriate protocol (e.g., IEEE 802.3, IEEE 802.5, or TCP/IP). Wireless techniques may, for example, include infrared (IR) techniques (e.g., IrDA) or radio frequency (RF) techniques (e.g., IEEE 802.11 or Bluetooth™).

In one mode of operation, when one of objects 108 arrives at object storage system 100, the object is directed to object entrance port 110, which acts to receive the object into object storage system 100. After arriving at object entrance port 110, object measuring system 117 of one of platforms 114 measures the weight and outer dimensions of the object. The object measuring system may perform its operations by using conventional components and techniques. For example, weighing an object may be accomplished by using load cells, strain gauges, or any other appropriate weight measuring devices. The object measuring system may convert the measurements into electrical signals (e.g., TTL signals, pulse-width modulated signals, broadband signals, or others) that are forwarded to computer 200, which determines if the weight and outer dimensions of the object are within the specified limits of the object storage system. If the object is not within the specified limits, the object is rejected and removed from the object entrance port.

If the object is admitted, object reception system 118 identifies the object by date, time, and entrance port. Object reception system 118 may perform this operation by using a time and date provided by computer 200. The object identification information may be associated with object position measurements, which may, for example, be achieved by optical, audio, visual, and/or mechanical techniques, by computer 200, to locate the object in the object storage system. The position sensors may include photo diodes, lasers, acoustic sensors, load cells, strain gauges, and/or trip levers. In certain implementations, the object may also be tagged and coded. The object's custodian (e.g., the person delivering the object to the object storage system) is also identified, and a receipt is issued by reception system 118. Identification may be achieved using a name, an address, a driver's license number, a business affiliation, a credit card number, and/or any other appropriate identifier, and the identifier(s) may be entered automatically (e.g., by the swipe of an information-encoded card) or manually (e.g., through a keypad). The receipt may function as a service contract between the custodian and the object storage system. Reception system 118 may perform its operations by using conventional components and techniques. In certain implementations, information-encoded cards, keyed-in identification codes, and/or magnetic-stripe tickets may be used. The custodian is also notified that the object reception is complete and, if applicable, is requested to unlock the wheel system of the object and and/or place the transmission of the object in a neutral position prior to leaving the object in object entrance port 110.

Computer 200 may at this time understand that the object is to be stored by system 100 and, hence, determine where the object is to be stored and define a path for routing the object to its storage location by selecting an appropriate storage level 132 for storing the object, an appropriate storage bay 140 for storing the object, and an appropriate elevator 180 for transporting the object to the selected storage level. In certain implementations, the computer may also determine a horizontal orientation for storing the object, in order to facilitate the appropriate exiting of the object at one of object exit ports 120. The orientation may, for example, be determined in accordance with the exit floor plan available or the object exit port selected by the custodian.

To determine where an object is to be stored, the computer may examine the current distribution of objects stored in the facility, the objects currently being processed by the facility, the anticipated object storage time, and/or any other appropriate criterion, and make a decision based on any number of appropriate criteria. For example, if the storage bays in the proximity of one elevator have a higher occupancy than those in the proximity of another elevator, the computer may decide to store an object in a storage bay of the elevator with the lower storage bay occupancy. As another example, if the storage bays of one storage level have a higher occupancy than those associated with another storage level, the computer may decide to store an object in a storage bay of the storage level with the lower proximate storage bay occupancy. As an additional example, if an object has just been assigned to a storage bay in the proximity of one elevator, another object may be assigned to a storage bay in the proximity of another elevator. As another example, if an object may be assigned to any number of storage bays, the selection of the storage bay may be based on the least time to move the object from the object entrance port to the storage bay. As a further example, as between objects that are to be stored temporarily and objects that are to be stored for a longer time (e.g., commuter automobiles versus shipping containers), the objects to be stored temporarily may be given preference to the least time to move an object from an object entrance port to a storage bay. Using the least time to move an object from an object entrance port to a storage bay may also be used in other appropriate situations. Also, determining the least effort to move an object from an object entrance port to a storage bay may be used. As an additional example, the computer may taken into account whether certain systems of the object storage system are malfunctioning or off-line.

To determine the routing of an object to a storage bay, the computer may examine the elevators in the proximity of the storage bay, the transfer carriage systems in the proximity of the storage bay, the objects currently being processed by the facility, the object transportation system, and/or any other appropriate criterion, and make a decision based on any number of criteria. For example, if a storage bay is closer to one elevator than another elevator, the computer may decide to use the elevator that is closer to the storage bay. This may often result from using a least time and/or effort criterion. As another example, if one elevator is busy storing or retrieving objects, the computer may decide to use another elevator in storing the object. As a further example, the computer may examine the routing of objects on the horizontal transportation system to ensure the proper queuing of objects waiting for elevators. For instance, the computer may reduce the queuing time for objects waiting for a particular elevator. As an additional example, the computer may consider whether any of the elevators or other appropriate systems are currently malfunctioning or off-line.

Similar considerations may be taken into account for determining where an object is to be delivered by the object storage system when a stored object is to be retrieved.

After the object has been received into system 100, a check is performed to make sure that the object's custodian has departed the area around the object, that the area around the object is clear, and that the object is ready for further processing into the system. This check may be performed by computer 200 using information from appropriate surveillance sensors. In other implementations, an entrance port operator may determine whether the custodian has left the entrance port area and whether the area around the object is clear, and subsequently notify the computer that the object is ready to for further processing into the system.

If the object is ready for further processing, it is moved towards one of object aligning systems 150 by one of object moving systems 119. Object moving systems 119 may, for example, be a chain-driven roller system. The object aligning system aligns the object for one of object mounting systems 160. At the object mounting system, the object is mounted on two frames, one frame for a first portion of the object and a second frame for a second portion of the object, forming mounted object 109.

From object mounting system 160, the mounted object is moved towards object orientation system 170. At object orientation system 170, the frames of the mounted object are engaged with one of longitudinal transportation systems 196a-b, the first of these corresponding to lane 112a and the second corresponding to lane 112b. The engaged longitudinal transportation system then centers the mounted object longitudinally with the center of object orientation system 170 under control of computer 200. The alignment may be accomplished using any appropriate type of sensors (e.g., IR, RF, or visual) and measurement techniques. After centering the mounted object longitudinally, object orientation system 170 centers the mounted object laterally with the center of object orientation system 170. The object orientation system then orients the mounted object so that the object may exit the system in a forward direction. In this implementation, the vehicle is reoriented 180°. In other implementations, however, the vehicle may not need to be reoriented or may be reoriented at any other appropriate angle.

After reorientation, lateral transportation system 192 transports the mounted object so that it aligns with one of elevators 180, as previously selected by computer 200. When the selected elevator is available, the corresponding one of longitudinal transportation systems 196c-e loads the mounted object on the elevator. The elevator then transports the mounted object to the appropriate storage level 132, which was previously selected by computer 200.

FIG. 1C illustrates storage level 132b, which is representative of other storage levels 132. As mentioned before, storage level 132b includes a number of bays 140. Storage bays 140 do not have to be the same width. Thus, some storage bays may store narrower objects and some objects may store wider objects.

Storage level 132 also includes transfer carriage systems 185. Transfer carriage systems 185 receive the mounted objects from elevators 180 and move them laterally to align with the storage bays. For example, transfer carriage system 185b is illustrated as moving a mounted object laterally. Once aligned with the selected one of storage bays 140, the transfer carriage system deposits the mounted object in the storage bay. For example, transfer carriage system 185a is illustrated as depositing a mounted object in storage bay 140q. Depositing the mounted object may occur with a series of horizontal and/or vertical movements of the mounted object. After depositing the mounted object, the transfer carriage system may return to an associated elevator 180 to receive another mounted object for storage or retrieve a mounted object from one of storage bays 140 for delivery to an associated elevator. As illustrated, the transfer carriage systems may operate simultaneously. Elevators 180 may also deposit mounted objects directly into storage bays aligned longitudinally therewith.

Each of storage bays 140 includes a longitudinal transportation system 142. Longitudinal transportation systems 142 are used for receiving the mounted objects in the bays and for delivering the mounted objects to transfer carriage systems 185. Longitudinal transportation systems 142 may, for example, include a pair of rails with associated sprockets. Storage bays 140 may also include any appropriate detent for securing the mounted objects received therein against movement while in storage.

The retrieval process for a mounted object works generally in the inverse of the storage process. Retrieval typically begins with custodian identification to the system, through a card, a code, a ticket, or otherwise, and payment for the storage. Computer 200 then understands that an object is to be retrieved by the system and, hence, locates the object based on the identity and determines a route for retrieving the object. The object is then retrieved and delivered to an object exit port. There are, however, a few other differences, which will be discussed below.

FIG. 1D provides a side view of object storage system 100. As illustrated, FIG. 1D provides another view of the processing of an object into the object storage system. As discussed previously, system 100 has first level 130 and storage levels 132. Also, as an object is processed into the system, it arrives at object entrance port 110, is accepted, and is moved to object aligning system 150a by object moving system 119a. Then, the object encounters object mounting system 160a, where it is mounted on the frames. From object mounting system 160a, the mounted object is conveyed to object orientation system 170, where it is oriented for an object exit port (not shown here).

Object storage system 100 also includes a frame recycling system 210. Frame recycling system 210 is responsible for retrieving frames from departing objects, storing them, and feeding them to object mounting system 160a. Frame recycling system 210 will be discussed in more detail below.

The example object storage system illustrated in FIGS. 1A-D has a variety of features. For example, the system allows the organization of the multiple facets of an object storage system to be managed to achieve efficiency in operating the system. Efficiency may be measured in terms of object transportation times, storage space distribution in relation to the number of elevators, and/or the ratio of the storage bays to system volume. Also, the system provides a number of object entrance and exit points and an efficient storage bay distribution grid-layout. Thus, high structural integrity may be maintained at lower system operational costs and less demanding performance of the mechanisms and components therein.

Efficiency may be achieved by rapid and simultaneous multi-tasking operations. To accomplish this, the computer receives data from various systems and components of the object storage system and coordinates their efforts. Efficiency is also found in the physical layout of the system. By locating storage bays in the area proximate each elevator, the stored objects may be quickly transported to at least one elevator. Also, the layout assists in reducing queuing times. But if necessary, the stored objects may also be transported to another elevator. This implementation balances the aspects of storage and retrieval times, the available system volume, and storage bay numbers. In effect, the implementation enhances the ratio of object numbers stored versus available storage volume and reduces storage and retrieval times.

For object storage system 100, and other similar implementations, the distribution dictates that the object storage system is as fast as the slowest of its components. For object storage system 100, the elevator may determine the most critical times to be measured: time waiting for the elevator, time for transporting an object to its storage level, and time for retrieving another object and preparing it for delivery.

As one example of how multi-tasking may facilitate increased efficiency, consider object storage system 100, which has three elevators, ten levels, and thirty storage bays per level, providing a capacity of three-hundred objects. In this object storage system, each elevator is associated with fourteen storage bays. It is estimated that the average time to transport (store or retrieve) one object is thirty seconds for one elevator. However, if both transports occur simultaneously, the system may average thirty-six seconds to execute both transports with the same elevator, even if the storage and retrieval levels for both transports are not the same. Thus, as opposed to storing or retrieving six objects per minute, which would take approximately fifty minutes to perform three-hundred transports (storage or delivery), in the case of storing and retrieving simultaneously, twice as many transports could be made in approximately twenty percent more time (i.e., approximately ten more minutes for six-hundred transports). Thus, if the storing and retrieving of objects was done simultaneously at full capacity, the system could, on the average, achieve approximately six-hundred transports in sixty minutes.

The coordination provided by the computer also increases reliability. Routing sequence motions are registered, and failures are easily detected. If necessary, alternate mechanisms and/or sensors may be substituted, and routing sequences may be modified, enabling the system to continue operating. The risk of operational discontinuities emanating from human intervention and mechanical failures is, therefore, reduced by early detection and evaluation, and the issuance of protective measures by the computer.

The computer also provides for administrative management of the object storage system. Items such as accepting objects from object custodians upon their arrival at the system and delivering objects to the object custodians upon their return may be managed. Also, the computer assures that objects not having appropriate physical parameters (e.g., weight or dimension) are not admitted into the system.

The system also allows multiple security devices, such as fire alarms, sensor and surveillance systems, telluric movement detectors, and the like, to be used to ensure security. These devices, along with the automation of the storage systems, can reduce the risk of vandalism. Moreover, the structure itself can follow conventional construction techniques with regards to regulations and protection systems. Also, the size and operations of the structure may be designed so that objects are protected from colliding against other objects, and the system's structure itself. Additionally, because no internal combustion motors are required to be running throughout the operations, toxic gas contamination levels are reduced.

In general, the object storage system is advantageous because of the strategy for simultaneous multi-tasking, anticipated selection and execution of routing paths, the simplicity of floor plans for the distribution of storage bays, elevator locations, the placement of entrance and exit ports, and the usage of a reduced number of lightweight conveyance components. Thus, it can address the greater object storing/retrieving problem while reducing energy costs, increasing available system space, and increasing operational viability.

Although FIG. 1 illustrates one example of an object storage system, other object storage systems may include fewer, additional, and/or a different arrangement of systems and components. For example, an object storage system may include any appropriate ratio between object entrance ports and object exit ports. Moreover, the object entrance ports and the object exist ports do not have to be on the same level. Also, the first level may include storage bays. As another example, an object storage system may include any appropriate number of elevators. The number of elevators may, for example, be dictated by the application for the object storage system. For instance, more elevators may be needed for a hospital visitor parking lot than for an exclusive container storage depot. The number of storage bays per elevator may be similarly adjusted. As a further example, an object storage system may reorient an object before mounting it on a frame. Other object storage systems, however, may not have an object orientation system. As an additional example, an object storage system may not have a horizontal transportation system.

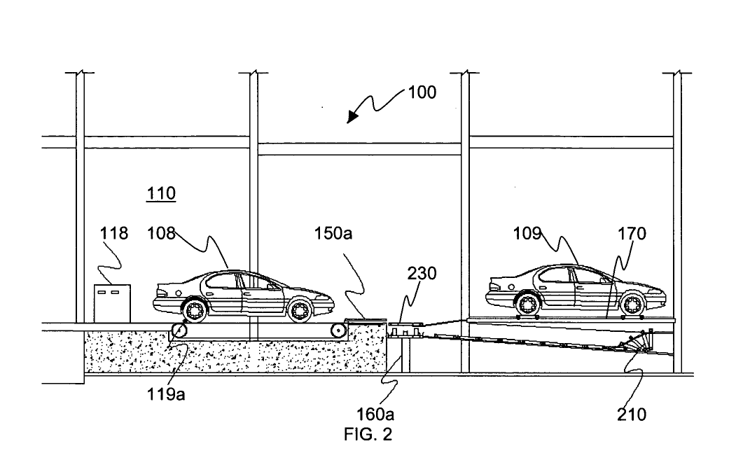

FIG. 2 provides a more detailed view of the object intake components of FIG. 1. As discussed previously, object entrance port 110 includes object reception system 118 and object moving system 119a. After acceptance of object 108, object moving system 119a moves the object towards object aligning system 150a, which aligns the object for object mounting system 160a.

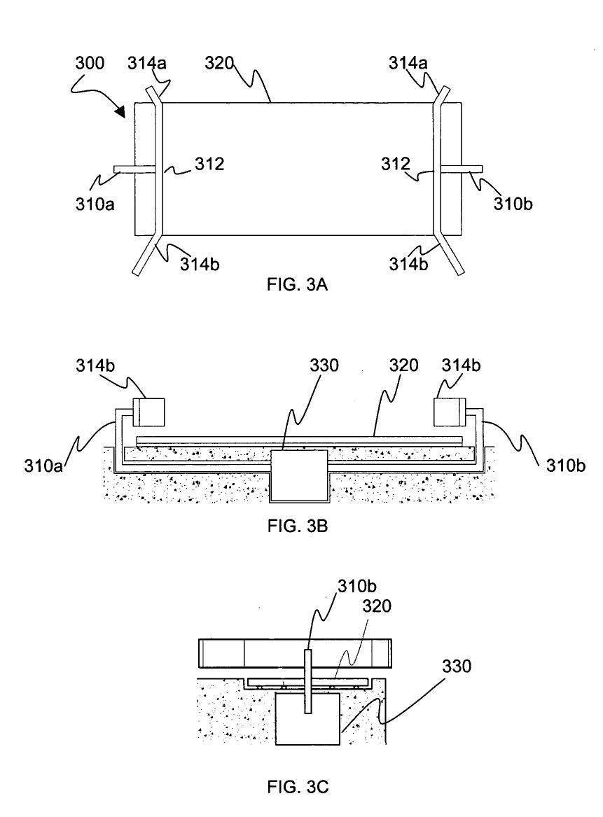

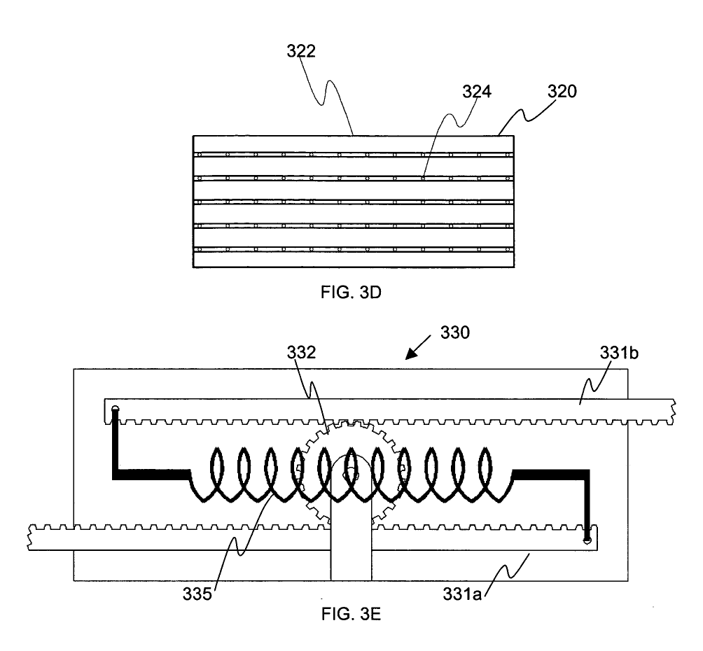

FIGS. 3A-E illustrate an object aligning system 300. Object aligning system 300 is one example of object aligning system 150a.

FIG. 3A provides a top view of object aligning system 300, FIG. 3B provides a front view of object aligning system 300, and FIG. 3C provides a side view of object aligning system 300. FIG. 3D provides a bottom view of a component of the object aligning system. FIG. 3E illustrates a component of the object aligning system.

In general, object aligning system 300 aligns the longitudinal centerline of the object with the centerline of another system component. To accomplish this, object aligning system 300 includes two opposing juxtaposition arms 310. Each of arms 310 includes a longitudinal length 312 with ends 314 outwardly bent. Arms 310 are coupled together by a centering compensation apparatus 330 such that the longitudinal lengths 312 of the arms are parallel and have an applied force that constrains the arms to close on themselves. During operation, the arms contact the corresponding outer portions of the object being processed (e.g., walls of tires) while the bottom of the object (e.g., treads of tires) rests on a gliding surface 320.

FIG. 3D illustrates gliding surface 320 in more detail. As illustrated, gliding surface 320 includes a floating plate 322 on which are mounted floating bearing strips 324. Floating bearing strips 324 facilitate movement of the object in both the longitudinal and lateral directions.

FIG. 3E illustrates one example of centering compensation apparatus 330 in cross-section. As can be seen, detent arms 331 couple arms 310 to centering compensation apparatus 330, which includes a linking device 332 (e.g., a sprocket) and a biasing device 335 (e.g., a spring). Linking device 332 ensures that arms 310 maintain an equal spacing from the centerline, and biasing device 335 applies a force to make arms 310 close on themselves.

In operation, centering compensation apparatus 330 constrains the centerline of the two parallel longitudinal lengths 312 to remain on the centerline of object mounting system 160 and to close on themselves. Furthermore, the longitudinal lengths are parallel to the appropriate axis of a subsequent system component. When the inner surface of one of these lengths is brought into contact with the corresponding outer surface of the object, the longitudinal arms will open to accept the object, and the contacted arm will apply a constraining force to the object to move the object until its centerline is collinear with the centerline of the object aligning system. The opposing inner surfaces of the longitudinal arms 310 are adapted to provide low resistance while moving and centering the object.

Returning to FIG. 2, after alignment of the object by object aligning system 150a, the object is loaded onto two object transportation frames 230 by object mounting system 160a. Object transportation frames 230 are used to transport the object throughout the rest of the system.

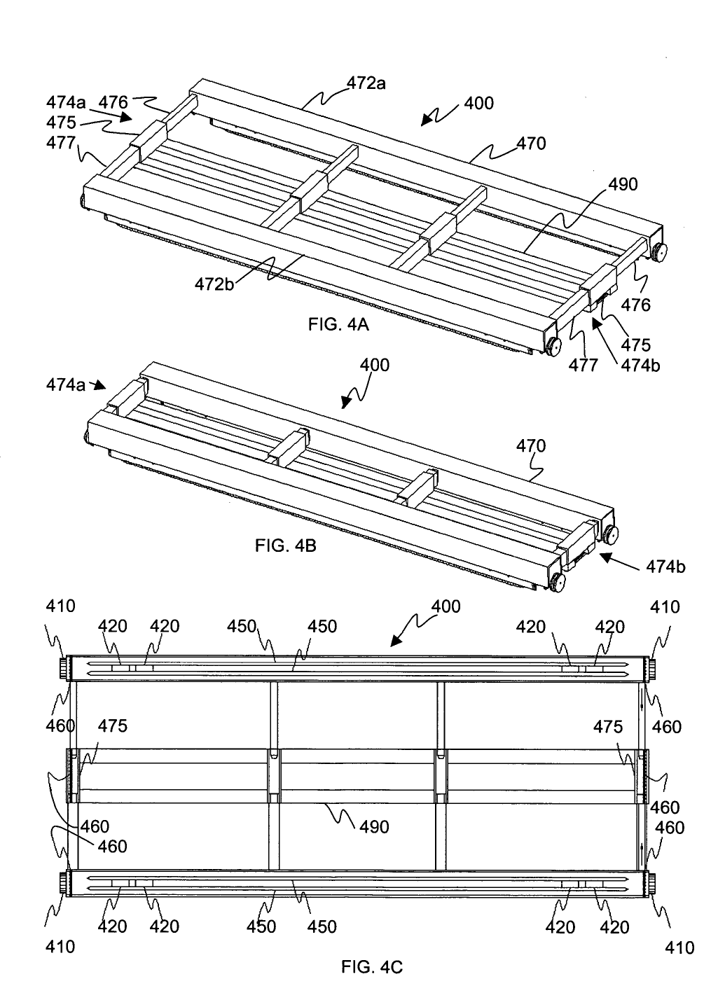

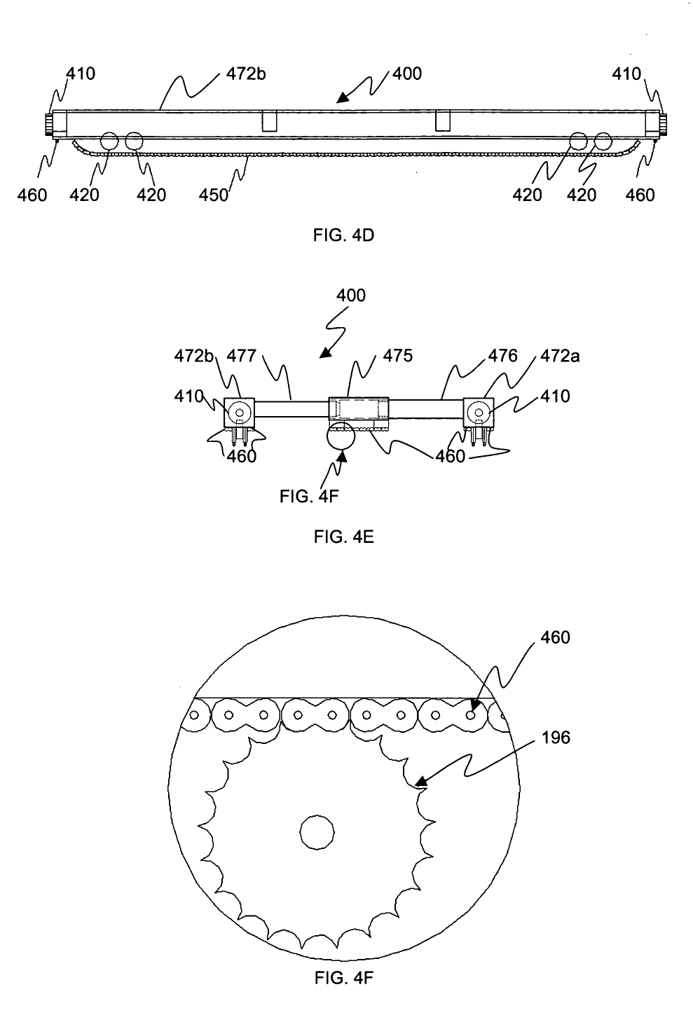

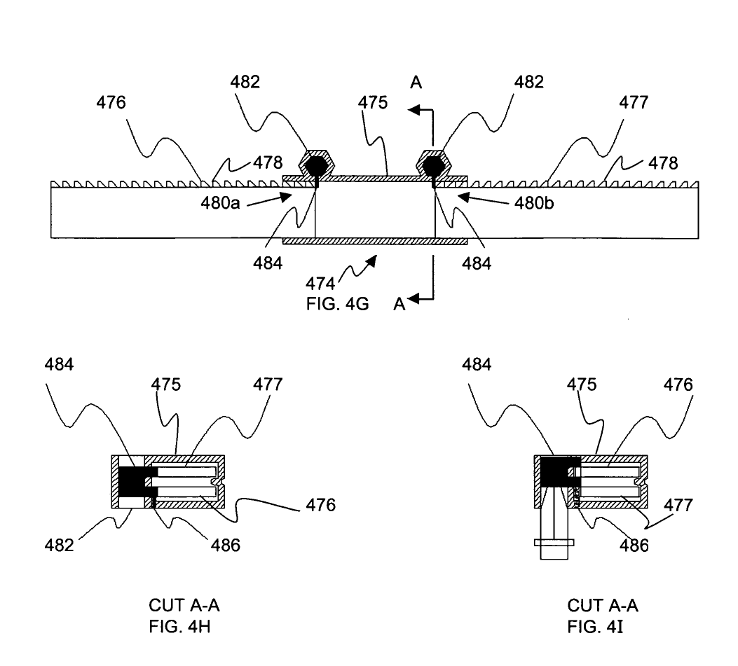

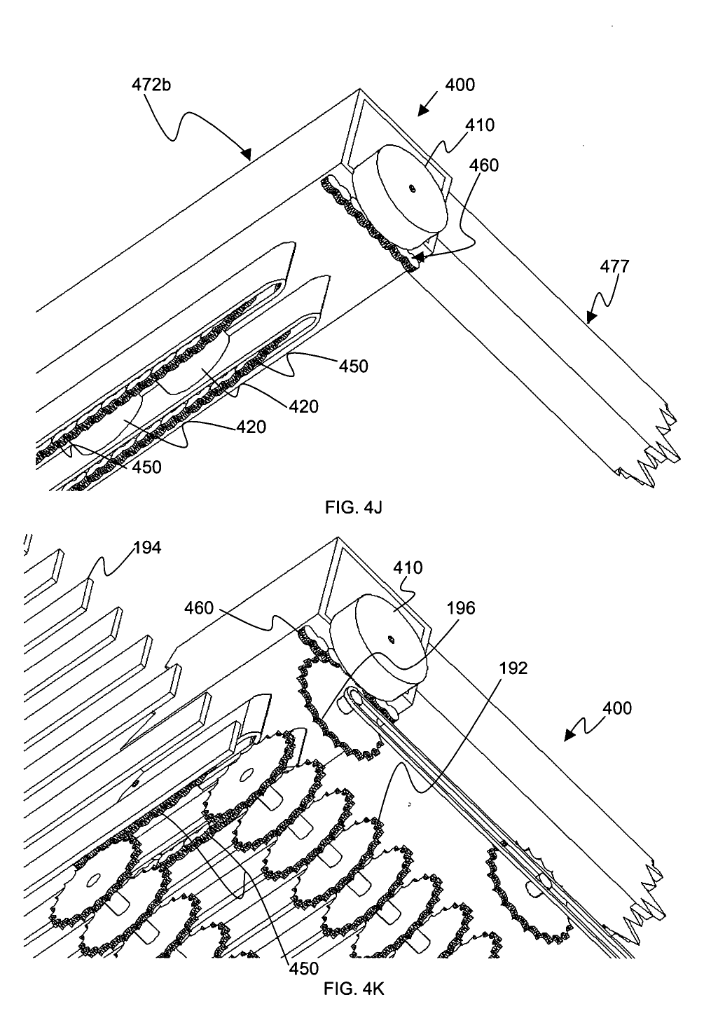

FIGS. 4A-K illustrate an object transportation frame 400. Object transportation frame 400 is one example of object transportation frames 230.

In general, FIGS. 4A-4F provide various views of object transportation frame 400. FIG. 4A is an isometric view of the object transportation frame in an expanded position, and FIG. 4B is an isometric view of the object transportation frame in a contracted position. FIG. 4C is a bottom view of the object transportation frame, and FIG. 4D is a front view of the object transportation frame. FIG. 4E is a side view of the object transportation frame. FIG. 4F is a blown-up view of a portion of FIG. 4D, showing the interaction of the object transportation frame with an example element of one of lateral transportation systems 192.

Object transportation frame 400 includes an outer expandable rectangular frame 470 with two outer frame members 472. As illustrated, outer frame members 472 are bars, but they may be rods, struts, beams, plates, or any other appropriate support components. Moreover, outer frame members 472 may have solid, hollow, or other appropriate cross-section. The ends of outer frame members 472 are coupled together by telescopic devices 474, which each include a locking housing 475 and two arms 476-477, which are rectangular in cross-section in the illustrated implementation. Telescopic devices 474 also allow rectangular frame 470 to contract, as shown in FIG. 4B.

Locking housings 475 are coupled to the ends of an inner frame structure 490 that has a centerline parallel to the centerline of outer expandable rectangular frame 470. As illustrated, inner frame structure 490 includes a set of parallel bars. However, the support members of inner frame structure 490 may be rods, struts, beams, plates, or any other appropriate support components. The horizontal plane defined by inner frame structure 490 is lower than the horizontal plane defined by the outer expandable rectangular frame.

As best shown in FIG. 4C, the bottom of object transportation frame 400 is adapted with rollers 410 that allow movement in the longitudinal direction of the system and rollers 420 that allow movement in the lateral direction of the system. The rollers may be wheels, tires, ball bearings, or any other appropriate supportive, rotating device, and are one example of a movement device for an object transportation frame. Object transportation frame 400 also includes sprocket chains 450 for movement in the lateral system direction by lateral transportation systems 192 and sprocket chains 460 for movement in the longitudinal system direction by longitudinal transportation systems 196. Sprocket chains are another example of a movement device for an object transportation frame.

The relationship between rollers 420 and sprocket chains 450 may be observed more clearly in FIG. 4D. The relationship between rollers 410 and sprocket chains 460 may be observed more clearly in FIG. 4E. FIG. 4F illustrates how sprocket chains 460 interact with an example component of longitudinal transportation systems 196. Sprocket chains 450 may interact similarly with components of lateral transportation systems 192.

FIGS. 4G-4I provide an enlarged, cross-sectioned view of one example of telescopic devices 474. As illustrated in FIG. 4G, arms 476-477 have teeth 478 with opposing pawl drops in this implementation. Locking housing 475 includes ratchet locking devices 480 that allow the arms to retract and expand controllably. Each of ratchet locking devices 480 includes a detent guide 482 and a detent 484 (e.g., a pin), which may interact with one or both of arms 476-477.

As illustrated in FIGS. 4H-4I, which are sections along line A-A in FIG. 4G, arms 476-477 are not longitudinally aligned. Thus, the arms may slide past each other in housing 475. Also, a biasing device 486 (e.g., a spring) normally holds detent 484 in a locking position in detent guide 482. This detent position is normally used when an object is mounted on the frame. However, a force may be applied to detent 484 to move it to an unlocked position, FIG. 4I. This position is used when the frame is being readied to receive an object. The force may be applied to detent 484 by any appropriate object.

FIGS. 4J-4K show a detailed isometric view of the bottom of the object transportation frame 400. FIG. 4J better illustrates several previously discussed components of object transportation frame 400. As illustrated, the object transportation frame includes outer frame member 472b, which is coupled to telescopic arm 477 for expansion and retraction. Also, the object transportation frame include rollers 420 and sprocket chains 450 for lateral system movement and rollers 410 and sprocket chains 460 for longitudinal system movement. FIG. 4K illustrates the interaction of sprocket chains 450 and sprocket chains 460 with example components of lateral transportation systems 192 and longitudinal transportation systems 196, respectively. As illustrated, lateral transportation system 192 and longitudinal transportation system 196 include sprockets that interact with the sprocket chains. Also, wheels 450 move on top of one of the guides of guide set 194. The support frames for sprocket chains 450 may assist in aligning the object transportation frame with the lateral transportation system. Imperfections in alignment between the object transportation frame and the lateral transportation system may be accounted for by play in the ratchet locking device 480 and/or increased or decreased loading on an object's tires.

Note that the sprockets of lateral transportation system 192 are grouped together in parallel sets, with each set coupled to an axis. By coupling the sets to an axis, binding may be reduced. In operation, each axis may be independently driven, or several, or possibly all, axes may be driven by the same motor. Driving each axis independently reduces the chance of isolated drive system failures incapacitating the lateral transportation system, but the axes may have to be monitored to ensure they maintain appropriate rotational speeds therebetween.

Object transportation frame 400 has a variety of features. For example, the object transportation frame may be relatively lightweight because a pair of frames does not have to have structure to account for wheel bases of varying size. The ability of the frames to be independently positioned compensates for varying-sized wheel bases. With lightweight frames, less power is used in moving them around the object storage system. Additionally, because the frames do not have the wheel-base compensation structure, they may be stored compactly, which allows them to be stored at or near the object exit and/or entrance ports. This eliminates the power needed to store the object transportation frames at a remote distance, and possibly reduces wasted object transportation time if the object transportation systems must be used to convey the object transportation frames to the storage location. Also, it allows for ready inspection of the object transportation frames and removal if a damaged frame is identified. It additionally eliminates the need for a one-to-one relation between object mounting structures and storage bays. That is, the object transportation frames may be used for storing any appropriate object in any storage bay. This allows object transportation structures to be removed and introduced while being able to fully utilize the object storage system. Additionally, the points at which the object transportation frames engage the object are relatively close to the movement mechanisms (e.g., the rollers and sprocket chains). This also allows the frames to be relatively lightweight, because it reduces spans between the object engagement points and the movement mechanisms, along which structural strength, and, hence, material, would be large.

Returning to FIG. 2, object 108 is loaded onto two of frames 230, one for the front tires and one for the rear tires in the illustrated example, by object mounting system 160. Frames are supplied to the object mounting system by frame recycling system 210, which will be discussed in more detail below.

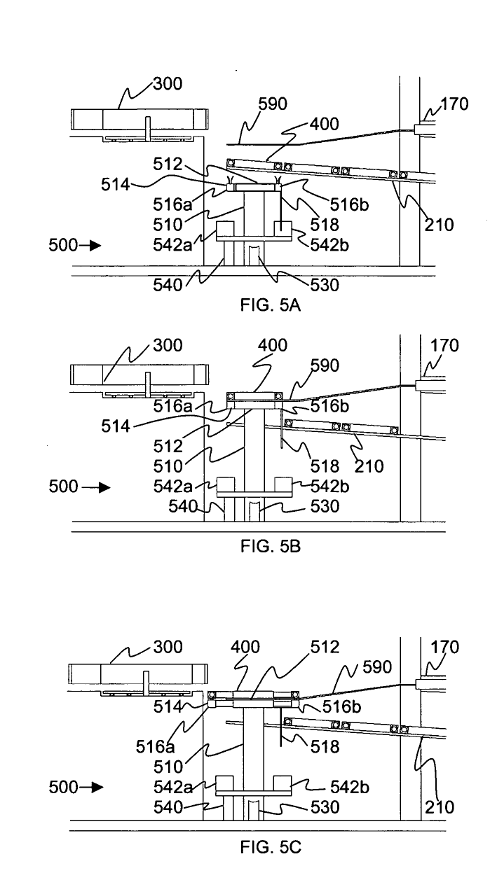

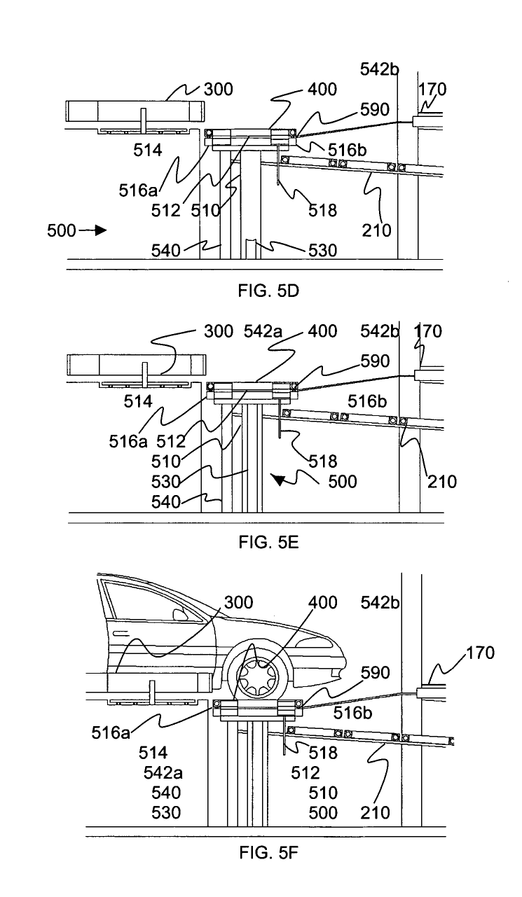

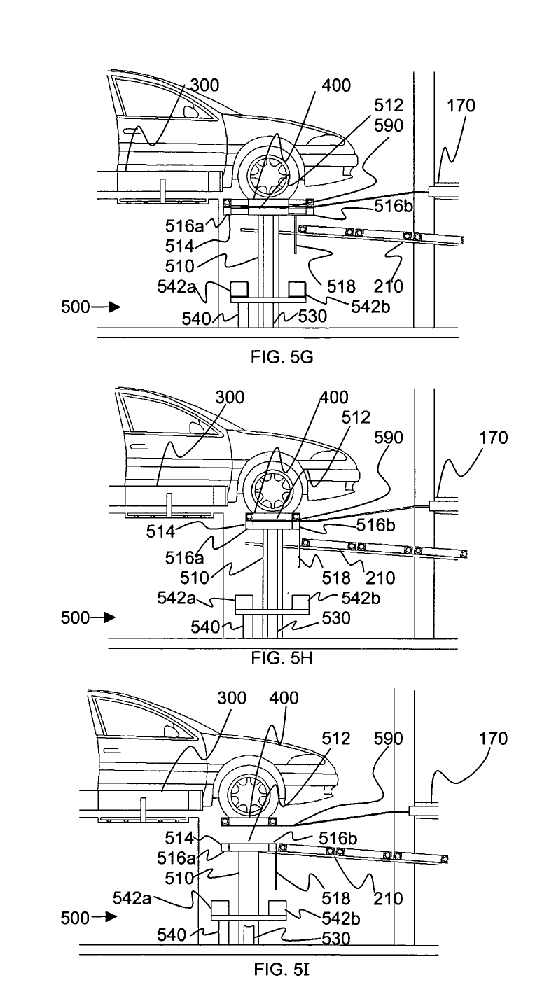

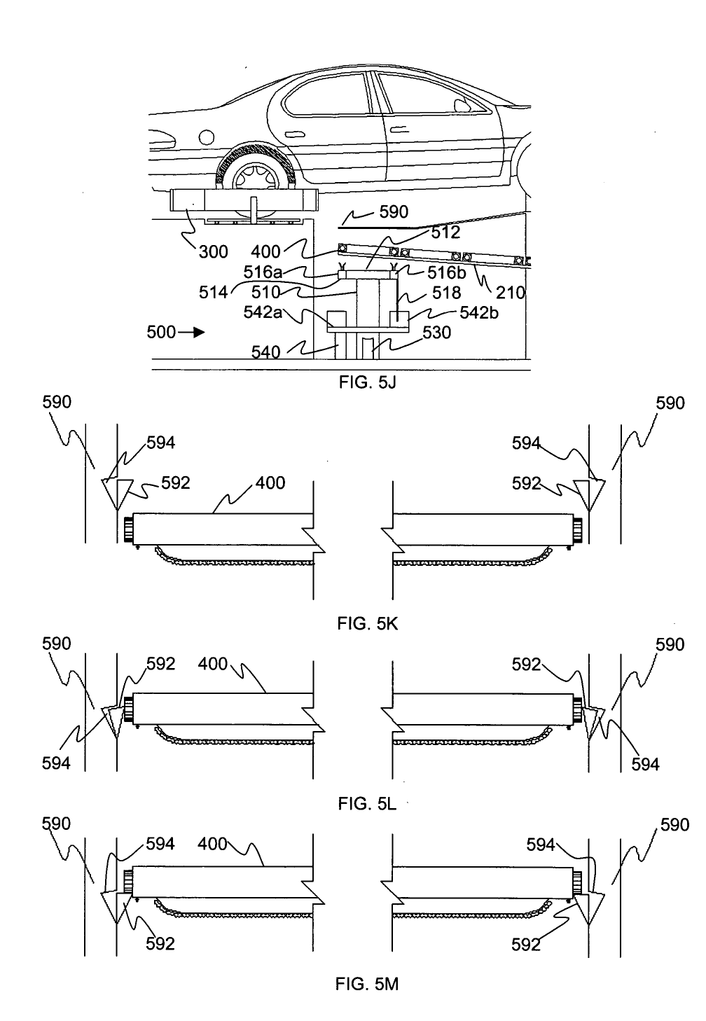

FIGS. 5A-M illustrate the components and operation of an object mounting system 500. Object mounting system 500 is one example of object mounting system 160a. Object mounting system 500 uses object transportation frames 400.

In general, FIGS. 5A-J illustrate a side view of the object mounting system at various stages of operation. FIGS. 5K-M illustrate a front view of the object mounting system at a particular stage of operation.

The purpose of object mounting system 500 is to mount the incoming object onto a first and a second object transportation frame 400. Object mounting system 500 includes a vertical piston 510, a vertical piston 530, and a vertical piston 540. In general, vertical piston 510 is responsible for elevating an object transportation frame to a position where it may engage the incoming object, preparing the frame for engaging the object, and engaging the frame with the object. To accomplish this, vertical piston 510 includes frame support platform 512 and horizontal piston 514, which is mounted to the top of vertical piston 510 and is responsible for expanding and contracting a frame to engage the object. Vertical piston 530 is responsible for raising and lowering a concave central bar, for the purpose of centering the object's tires on the object transportation frame. Vertical piston 540 is responsible for elevating and lowering two support bars 542, which assist in transferring the object onto the frame. Vertical piston 510, horizontal piston 514, vertical piston 530, and vertical piston 540 may have pneumatic, hydraulic, or any other appropriate activation.

In one mode of operation, object mounting system 500 executes multiple movements to mount an object on an object transportation frame. The movements are in the vertical direction and the horizontal direction. These movements may be performed under the command of computer 200.

In initiating the object mounting process, one of object transportation frames 400 is positioned above object mounting system 500, as shown in FIG. 5A. The object transportation frame is in a contracted condition when it arrives at the object mounting system.

FIG. 5B shows the result of actuating vertical piston 510 to lift the object transportation frame. During this operation, frame support platform 512 engages and supports the frame. Horizontal piston 514 may also extend outwardly in opposite directions. In doing so, extremities 516 of the horizontal piston are brought into contact with the object transportation frame. As the piston extends further, the action releases ratchet locking devices 480 of the object transportation frame so that it may be expanded. Note that vertical piston 510 also includes a detent 518 to prevent another object transportation frame 400 from currently being received by the object mounting system.

FIG. 5C shows another result of actuating horizontal piston 514. As illustrated, the actuation expands object transportation frame 400. Object transportation frame 400 is now ready to receive the front tires of the object.

Vertical piston 510 also raises the object transportation frame to engage it with a track 590 of object mounting system 500, as shown in FIGS. 5K-M. Track 590 includes hinged support arms 592 and recesses 594 associated therewith. In their normal state, support arms 592 protrude from recesses 594, FIG. 5K. Support arms 592 may be actuated by springs, pistons, or other appropriate technique.

When vertical piston 510 raises object transportation frame 400, support arms 492 are moved into recesses 594, FIG. 5L. This operation may result in the object transportation frame being slightly above than the bottom of the incoming object. After the object transportation frame clears the support arms, the support arms return to their normal state. Vertical piston 510 then lowers the object transportation frame so that it engages the support arms, FIG. 5M. The object transportation frame is then at the level of the incoming object.

FIG. 5D illustrates the actuation of vertical piston 540. As mentioned earlier, vertical piston 540 includes support bars 542. Support bars 542 are responsible for filling, at least in part, the space in the object transportation frame due to its expansion, FIG. 4C. Also, the support bars assist in centering the object's tires on the object transportation frame. The tops of the supports bars may be on the same level as the bottom of the incoming object.

FIG. 5E illustrates the actuation of vertical piston 530. As mentioned previously, vertical piston 530 includes a concave bar that assists in centering the tires of the object on the object transportation frame, and also supporting the object. The height of the concave bar may be slightly lower than that of support bars 542.

The object mounting system is now ready to receive the incoming object. Thus, the object is moved forward using object moving system 119 (not shown here) and centered by an object aligning system so that the object's forward wheels come into contact with the object transportation frame, the concave bar, and the support bars.

FIG. 5F shows the object mounting system receiving the incoming object. As shown, the object's front tires are centered on the object transportation frame and are supported by the concave bar.

FIG. 5G shows the object mounting system with vertical piston 540 retracted. Support bars 542 are no longer needed because the object's front tires are centered on the object transportation frame and supported by vertical piston 530. The object tire's may also be supported by the object transportation frame.

FIG. 5H shows the result of retracting horizontal piston 514. This retraction causes the outer elements of the object transportation frame to retract and engage the tires of the incoming object. In particular implementations, the object's tires, and, hence, the object, are predominantly supported by the outer components of the frame. That is, the inner components do not touch the tires, or if the inner components do touch the tires, the components provide only minimal support. The object is now mounted on the first object transportation frame.

Once the incoming object's tires have been mounted on the object transportation frame, the other pistons are no longer needed. Thus, as shown in FIG. 5I, vertical piston 530 and vertical piston 510 are retracted. Note that the retraction of vertical piston 510 leaves the object transportation frame in a locked position. For frame 400, ratchet locking devices 480 engage the next available teeth 478 on arms 476-477, FIG. 4G.

The operations of object mounting system 500 may be accomplished as a result of data gathered by various sensors of the system. The information may be delivered to computer 200, which may send commands to various actuators of system 500. For example, the system information delivered to computer 200 may indicate that the front tires of the object are engaged by the first object transportation frame, and the computer may command object mounting system 500 to return to its initial position.

FIG. 5J illustrates the object mounting system as the object is moved forward after mounting of the front tires. As the object moves forward, the way is cleared for another object transportation frame 400 to be brought in and positioned over object mounting system 500 for mounting the object's rear tires. The process of mounting the object's rear tires onto the second object transportation frame is similar to the process described above for mounting the object's front tires onto the first object transportation frame.

Returning to FIG. 2, after the object has been mounted on the object transportation frames by object mounting system 160a, the object is moved toward object orientation system 170. As with object 108, mounted object 109 may move under the control of the computer. The movement and/or position of the mounted object may be detected by sensors, and electronic signals transmitted to the computer. These signals may, for example, announce that the mounted object is now ready to be moved to object orientation system 170.

To convey the mounted object to object orientation system 170, one of longitudinal transportation systems 196a-b is used. As shown in FIG. 1B, longitudinal transportation systems 196a-b have a pair of guides 198, which engage rollers 410 of the object transportation frames, FIG. 4C. The mounted object may be moved longitudinally using a number of opposing sprocket pairs, each mounted laterally in the proximity of the guiding tracks of the longitudinal transportation system, FIG. 4K.

Opposing pairs of sprockets may be mounted coaxially on the same axis. In certain implementations, the movement of the sprockets are driven by a common device, such as, for example, an electric motor (AC or DC), a hydraulic motor, a pneumatic motor, or any other appropriate mechanical power output device. Other processes for moving the sprockets independently or dependently could also be used.

The longitudinal movement of the mounted object is halted when the mounted object is onboard object orientation system 170, as detected by position sensors. The longitudinal center of the mounted object is made to coincide with the center of object orientation system 170 (e.g., the forward and rear edges of the mounted object are equidistant from the center of the object orientation system). To accomplish this, commands from the computer may be used to energize a mechanical power output device, which may be external to the object orientation system, based on the information from the position sensors. The position sensors may operate according to optical, audio, visual, mechanical, or other appropriate techniques.

Once the longitudinal center of the mounted object aligns with the center of object orientation system 170, the mounted object is maneuvered laterally until the center of the mounted object is over the center of the object orientation system. The lateral maneuvering may be accomplished by a mechanical power output device that is or is not part of the object orientation system. Once the centering is complete, the computer is notified, and it commands the reorienting of the mounted object in the proper direction. The proper direction may be defined by the direction the object will take upon leaving the object storage system.

The mounted object is then loaded onto lateral transportation system 192a, which has multiple guide sets 194, FIG. 1B. Lateral transportation system 192a may then transport the mounted object to one of elevators 180, which may have been previously selected by computer 200.

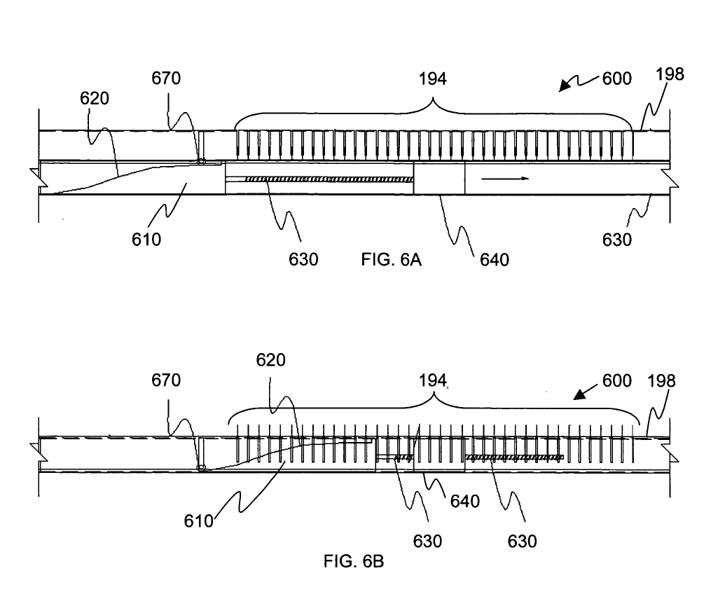

FIGS. 6A-B illustrate a system 600 for transferring the mounted object between lateral transportation system 192a and longitudinal transportation systems 196. System 600 could also be used for transferring the mounted object onto the lateral transportation system from one of the longitudinal transportation systems.

As illustrated, transfer system 600 includes a ramping apparatus 610. The ramping apparatus includes a cam follower 670, to which is coupled one of guides 198 of a longitudinal transportation system. Cam follower 670 is engaged with ramping cam 620, which is coupled to a screw motor 640 by a screw 630, screw motor 640 and screw 630 being one example of a ramp drive system. When screw motor 640 is properly powered, ramping cam 620 moves forward, lowering both the cam follower and guide 198. As the guide is lowered, guide sets 194 (only one of which is shown) of the lateral transportation system protrude above the longitudinal transportation system. Rollers 420 on the bottom surface of object transportation frame 400, FIG. 4D, would engage with two of the guides in each guide set 194. Also, sprocket chains 450 would engage with sprockets of the lateral transportation system (not shown here). The mounted object is then ready to be moved by the sprocket system of the lateral transportation system to one of elevators 180.

The mounted object may be moved by the lateral transportation system so that is in front of the entrance to a selected one of elevators 180. Note that the selected elevator may not have arrived yet, as it may be performing other operations. When the selected elevator arrives, the mounted object is loaded onto the elevator.

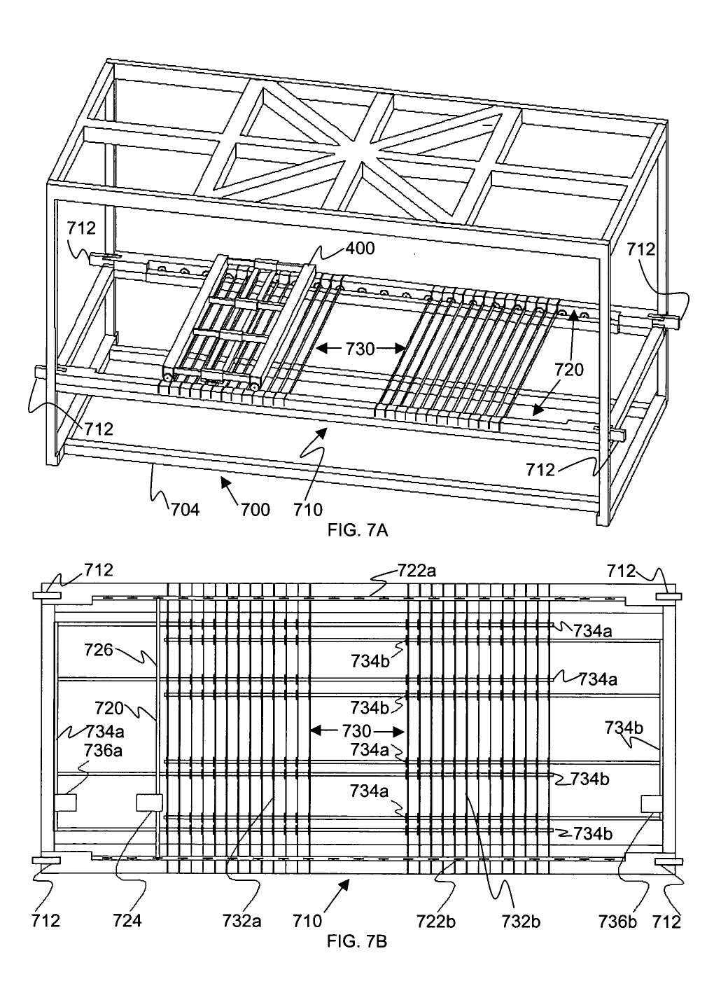

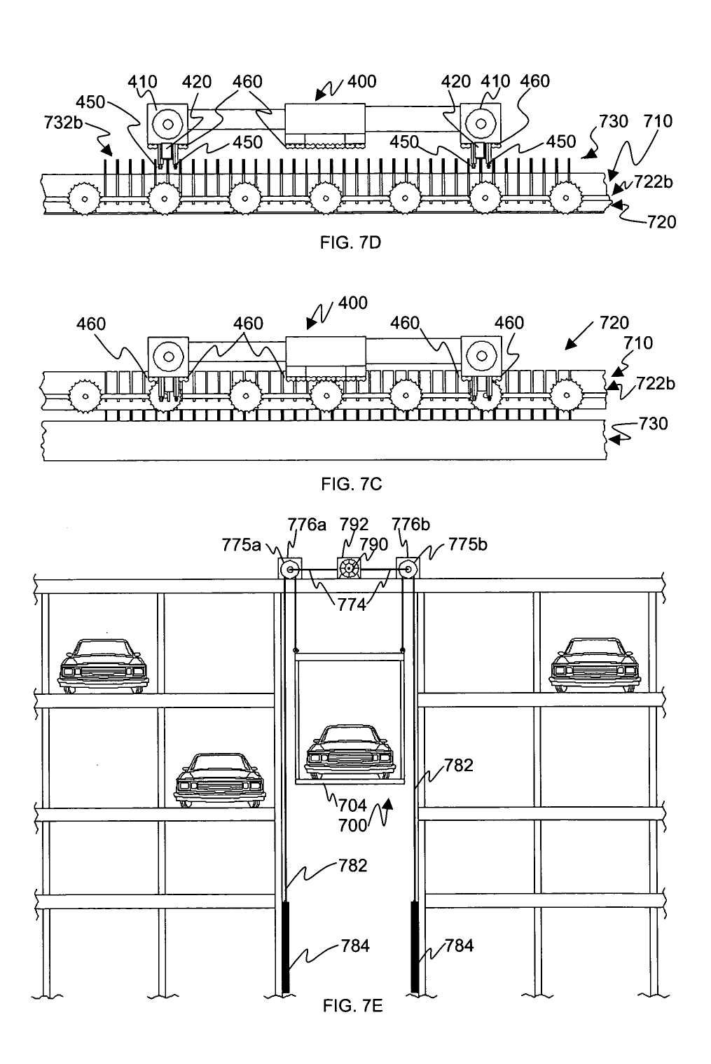

FIGS. 7A-E illustrate an elevator 700. Elevator 700 is one example of elevators 180.

FIG. 7A provides an isometric view of elevator 700. As illustrated, elevator 700 includes a cage 704 and an object support platform 710, which will be discussed in more detail below. In general, object support platform 710 supports the mounted object while in elevator 700. FIG. 7B provides a top view of object support platform 710. Elevator 700 may be vertically positioned by a cable-pulley arrangement, a piston, or any other appropriate technique.

Object support platform 710 includes a longitudinal drive system 720 and a lateral drive system 730. In general, longitudinal drive system 720 assists in transferring a mounted object to and from the elevator at first level 130. Also, lateral drive system 730 assists in transferring a mounted object to and from the elevator at storage levels 132.

When the mounted object is at the entrance of one of elevators 180 on first level 130, FIG. 1B, the mounted object is transferred from lateral transportation system 192 onto object support platform 710. In one mode of operation, the transfer is accomplished by positioning object support platform 710 slightly higher than lateral transportation system 192. Then, detents 712 (e.g., bolts) located within object support platform 710 are extended outwardly. Each extended detent 712 is aligned above a corresponding platform support plate coupled to the elevator shaft structure (not shown here). After extending detents 712, object support platform 710 is lowered until the extended detents 712 come to rest on the corresponding platform support plates. In other implementations, detents 712 may be engaged with the elevator shaft structure in other manners. Also, detention devices other than detents 712 may be used.

Object support platform 710 is now decoupled from movement of elevator 180, which may occur due to compression or tension upon loading or unloading, component slippage, gear play, mechanical failure, and/or other appropriate mechanical movement. The process of transferring the mounted object onto the elevator may proceed in a safe and secure manner. In the illustrated implementation, cage 704 has been separated from object support platform 710 to further facilitate the decoupling.

Additionally, the corresponding one of longitudinal transportation systems 196 is engaged with the mounted object. This may, for example, be accomplished based on commands issued by computer 200 to a ramping apparatus similar to the one illustrated by FIGS. 6A-B. By this operation, the object transportation frames are transferred from the lateral transportation system to a longitudinal transportation system. For example, rollers 410 of object transportation frames 400, FIG. 4C, may come into contact with guides 198 of a longitudinal transportation system, and sprocket chains 460 on the bottom of the object transportation frames, FIG. 4F, may come into contact with a sprocket system. The sprocket system proceeds to transfer the mounted object onto object support platform 710.

Sensors are used to determine when at least part of one object transportation frame is on object support platform 710. At this point, or at a later point, longitudinal drive system 720 is engaged with the object transportation frame to finish transferring and/or positioning the mounted object on object support platform 710.

As best illustrated in FIG. 7B, longitudinal drive system 720 includes a number of opposing sprockets 722 located near the outside of object support platform 710. Sprockets 722 are coupled to a motor 724 by a shaft 726. Motor 724 simultaneously drives sprockets 722.

FIG. 7C provides a side view of elevator 700 with one of object transportation frames 400 in contact with longitudinal drive system 720. As illustrated, sprocket chains 460 of the object transportation frame are engaged with sprockets 722b of the longitudinal drive system to move the object transportation frame during transferring and positioning. Lateral drive system 730 is lower than longitudinal drive system 720 at this stage.

When the mounted unit is loaded onto object support platform 710, the mounted object is maneuvered using longitudinal drive system 720 until the forward and rear edges of the mounted object are equidistant from the elevator coordinate system center. At the conclusion of the centering maneuver, longitudinal drive system 720 may be lowered so that the object transportation frames engage lateral drive system 730. This operation may use a ramping apparatus like in FIGS. 6A-B.

As best illustrated in FIG. 7B, lateral drive system 730 includes guide sets 732 and several sets of opposing sprockets 734 located near guides 732. Sprockets 734a are coupled to a motor 736a by a shaft 738a. In turn, sprockets 734b are coupled to a motor 736b by a shaft 738b. Motors 736 may simultaneously drive sprockets 734.

FIG. 7D provides a side view of object support platform with object transportation frame 400 engaged with lateral drive system 730. As can be seen, longitudinal drive system 720 has been lowered so that sprockets 722b no longer engage sprocket chains 460. Also, rollers 420 are now in contact with two of guides 732b. Lateral drive system 730 also includes sprockets 734 that engage sprocket chains 450, but the sprockets have not been shown for clarity.

The mounted object now rests on lateral drive system 730, the sprockets of which may be locked while in contact with sprocket chains 450 on the bottom of the object transportation frames. When the mounted object rests on the lateral drive system, proper engagement may be ensured by moving the mounted object slightly in each direction. A position sensor may be used to determine whether the mounted object moves the appropriate amount. If engaged properly, the sprockets are locked, and the elevator is ready to move.

On command of the computer, elevator 700 moves to the selected storage level 132. In accomplishing this, the elevator lifts object support platform 710 so that detents 712 are longer engaged with the elevator shaft structure. Detents 712 are then retracted, and the elevator moves to the selected storage level.

On reaching the selected storage level 132, the object support platform 710 is positioned slightly higher than the storage level. The computer then commands detents 712 to extend outwardly. Each extended detent 712 is aligned above a corresponding elevator platform support plate coupled to the elevator shaft structure (not shown here). The object support platform is then lowered until the extended detents 712 come to rest on corresponding elevator platform support plates. The object support platform 710 is now decoupled from movement of the elevator 700, and the process to unload the mounted object proceeds in a safe and secure manner.

Depending on the location of the previously selected storage bay 140, FIG. 1C, the mounted object is moved in the longitudinal or lateral direction. If the movement is in the longitudinal direction, the computer commands the mounted object to be unloaded onto a longitudinal transportation system 142 of the previously selected storage bay. This transfer calls for the elevator powered ramping apparatus onboard the elevator (not shown here) to reengage longitudinal drive system 720 with object transportation frames 400 of the mounted object. The elevator powered ramping apparatus is within the elevator structure in the illustrated implementation. The computer, using a transferring procedure similar to that described previously, then controls the movement of the mounted object into the previously selected bay 140 by using longitudinal drive system 720 and a longitudinal transportation system 142 located within the selected bay. Longitudinal transportation system 142 may be similar to one of longitudinal transportation systems 196. A mechanical stop (not shown here) located at the far end of the bay may determine the final position of the mounted object. Once in the final position, the computer is informed that the mounted object is positioned for storage and commands a locking device (not shown here) to be applied to the mounted object to deter further movement.

In the case where the mounted object is to exit the elevator in the lateral direction, the height of lateral drive system 730 is typically already at the same height as transfer carriage system 185. Hence, the lateral unload movement is initiated on commands issued by the computer to apply power to lateral drive system 730, activating sprockets 734, which are matched to sprocket chains 450 on the bottom of the mounted object. Thus, activating the sprockets moves the mounted object out of the elevator onto transfer carriage system 185.

FIG. 7E provides a cutaway of an object storage system to show an end view of elevator 700. As illustrated, elevator 700 is suspended by cables 782, which are coupled to the corners of elevator cage 704. Cables 782 are routed through pulleys 775 at the top of the elevator shaft and are coupled to weights 784, which counterbalance cage 704. Pulleys 775 support cage 704 and also allow it to be moved vertically by a power drive device 790. Power drive device 790 may operate using electricity (AC or DC), hydraulics, or other appropriate power. Power drive device 790 is coupled couple to the pulleys by a drive transmission 792, a first power shaft 774, and shaft transmissions 776. A second power shaft is also used, but it is not visible here. Computer 200 may control the power drive device, using a programmable velocity servo algorithm, for example.

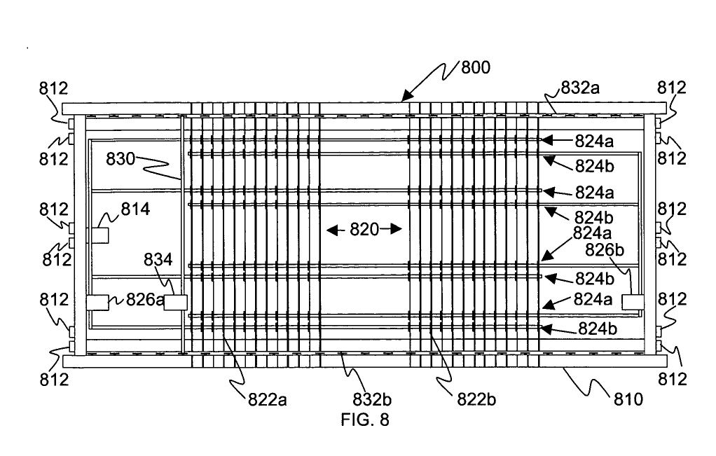

FIG. 8 illustrates a transfer carriage system 800. Transfer carriage system 800 is one example of transfer carriage system 185.

As illustrated, transfer carriage system 800 is similar to object support platform 710. Transfer carriage system 800 includes a lateral drive system 820 and a longitudinal drive system 830. Lateral drive system 820 includes two guide sets 822. Located proximate the guides are opposing sprockets 824. Sprockets 824a are driven by a motor 826a, and sprockets 824b are driven by a motor 826b. Lateral drive system 820 can be used for transferring the mounted object from and to the elevator. Longitudinal drive system 830 includes opposing sprocket lines 832. Sprocket lines 832 are driven by a motor 834. Longitudinal drive system 830 can be used for transferring the mounted object to and from the storage bays.

Transfer carriage system 800 also includes a carriage support frame 810. Mounted on carriage support frame 810 are rollers 812, which allow the transfer carriage system to move in the lateral direction. Carriage support frame 810 also includes a motor 814 for driving rollers 812.

Once a mounted object is onboard transfer carriage system 800, motor 814 is powered to convey the mounted object to the previously selected storage bay 140. Once at the storage bay, the center of the mounted object is aligned with the selected storage bay using information provided by a position sensor system. Once aligned, the mounted object is moved into the storage bay until the mounted object comes in contact with a mechanical stop (not shown here), located in the storage bay. As previously described, a locking device is applied to deter further movement of the mounted object.

The process for retrieving stored objects is typically initiated by the object custodian returning to system 100, presenting his receipt, and paying the appropriate fee. Upon determining that the appropriate fee has been received, computer 200 determines in which of storage bays 140 the object is stored and determines a process for retrieving the object. For example, the computer may select and sequence an object exit port, a transfer carriage system, and an elevator.

The retrieval process is basically performed by inverting the sequence for storing an object from the stage at which the mounted object is loaded on the elevator to the stage at which the mounted object is loaded into the selected storage bay. Once elevator 180 arrives at first level 130, however, several differences occur for the example object storage system 100.

At first level 130, there are two directions for removing the mounted object from the elevator—the longitudinal direction and the lateral direction, FIG. 1B. If the object is to exit the elevator in the longitudinal direction, the height of object support platform 710 is adjusted so that the mounted object is slightly below the object exit port level. The object is then dismounted from the object transportation frames by an object dismounting system and delivered to the object exit port 120. If the object is to exit the elevator in the lateral direction, one of lateral transportation systems 192b-d is used to convey the mounted object to an adjacent platform where a second object dismounting system is located.

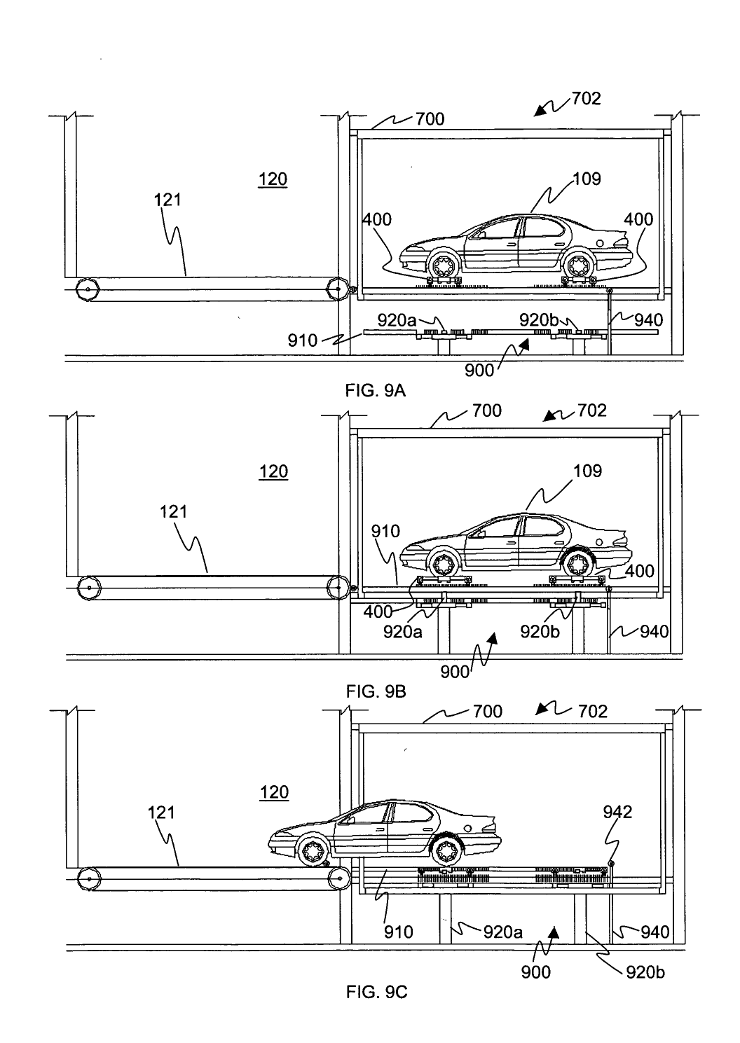

FIGS. 9A-C illustrate an example object dismounting system 900. Object dismounting system 900 may have components and operations similar to object mounting system 500 in FIG. 5.

As illustrated, object dismounting system 900 is located underneath a shaft 702 of elevator 700 and includes platform 910 and pistons 920. Platform 910 is coupled to piston 920a and piston 920b. Platform 910 meshes with the object support platform of elevator 700 to provide support for mounted object 109 as it is removed from the object transportation frames and the elevator. Object dismounting system 900 also includes an object moving system 940. In the illustrated implementation, the object moving system includes an arm 942 that can extend into the elevator to engage the object. The arm may be driven by any appropriate device.

In operation, pistons 920 activate to raise support platform 910 to provide support for removing the object from the object transportation frames and the elevator. Pistons 920 also engage and release detents 484 of ratchet locking devices 480 (not shown here) on the corresponding front and rear object transportation frames 400. The object now has a level and stable platform and is pushed off of the object transportation frames and out of the elevator by object moving system 940. When in object exit port 120, the object is moved by an object moving system 121 and delivered to the custodian. Object moving system 121 may, for example, be a chain and roller assembly.

Once the object has been removed from the elevator and engaged by object moving system 121, pistons 920 retract, lowering platform 910. The dismounting system is now clear for moving the object transportation frames to frame recycling system 210, FIG. 1D.

If the object is to exit from the elevator in the lateral direction, the mounted object is moved in the lateral direction by the lateral drive system of the elevator and the associated one of lateral transportation systems 192b-d, FIG. 1B. The mounted object is then aligned in front of another object exit port 120 and removed from the object transportation frames. The system and sequence for removing the object from the object transportation frames at another object exit port may be the similar to the system and sequence described above.

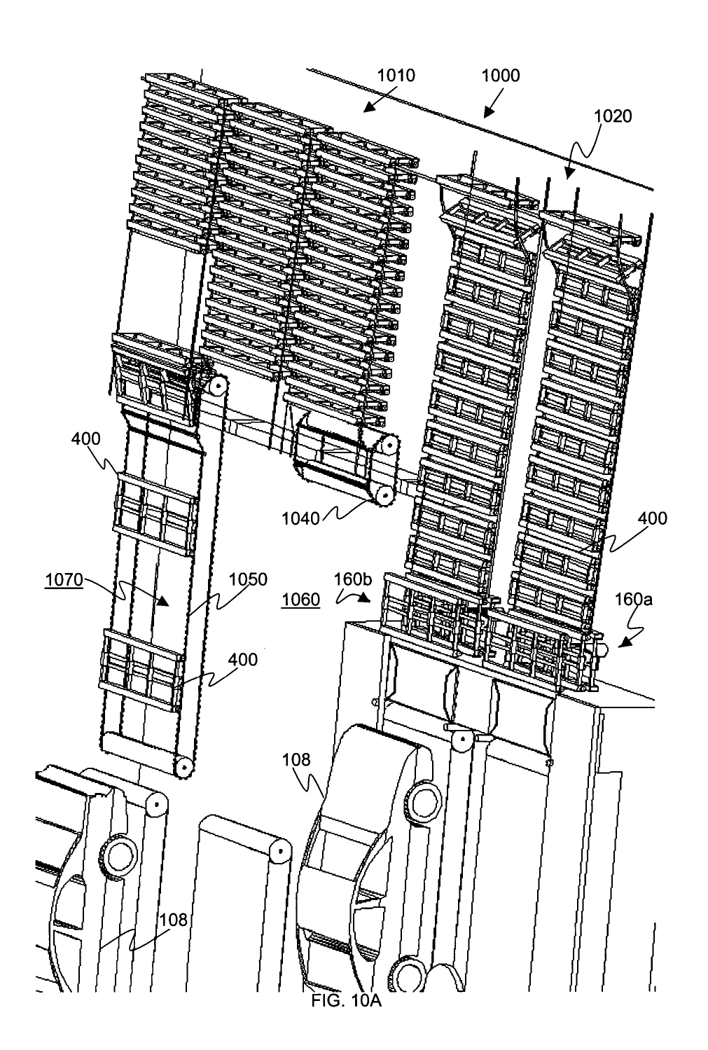

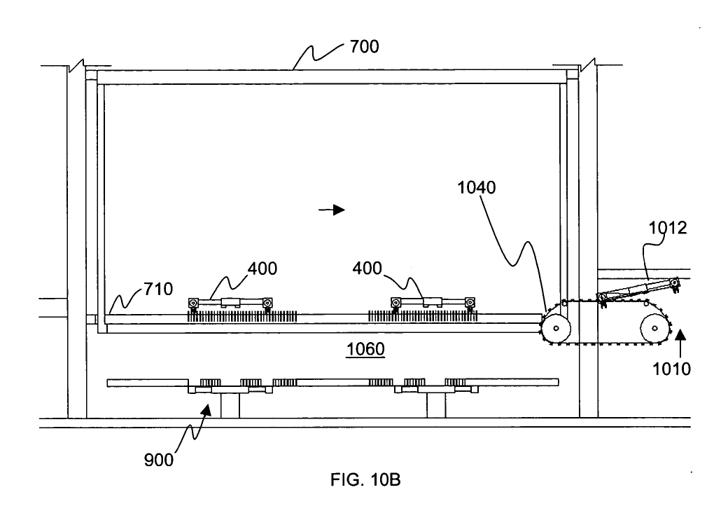

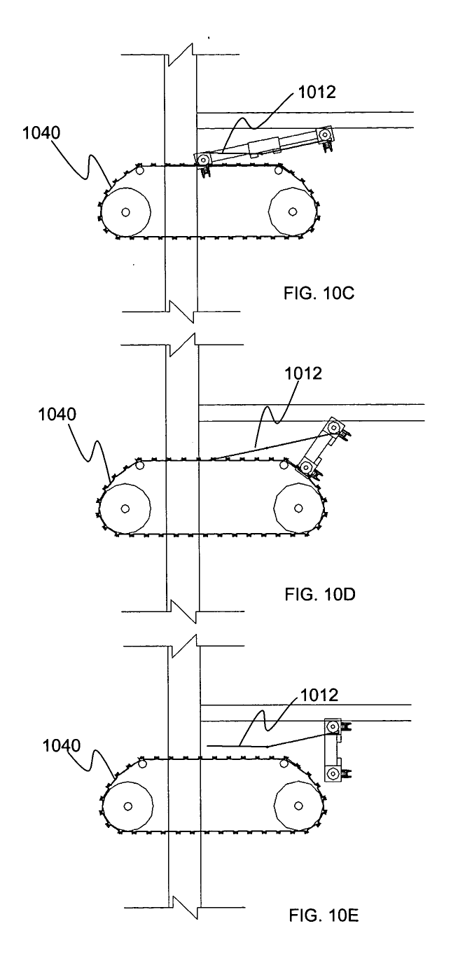

FIGS. 10A-E illustrate an object transportation frame recycling system 1000. Object transportation frame recycling system 1000 is one example of object transportation frame recycling system 210.

In general, frame recycling system 1000 is adapted to accept object transportation frames from an object dismounting area, store them, and feed them to object mounting system 160. The frame recycling system may be an automated system working independently of computer 200. As such, the frame recycling system may use an independent network of position sensors and gates. The frame recycling system may inform computer 200 when frames are removed and/or supplied.

FIG. 10A provides an isometric view of frame recycling system 1000. As can be seen, frame recycling system 1000 includes a frame storage system 1010 and a frame feed system 1020. Frame storage system 1010 stores frames after an object has been dismounted therefrom, and frame feed system 1020 provides stored frames to object mounting systems 160. Frame recycling system 1000 also includes a frame conveying apparatus 1040 and a frame conveying apparatus 1050, which accept frames from an object dismounting area 1060 and an object dismounting area 1070, respectively. The object dismounting systems for the object dismounting areas are not shown here for clarity. FIG. 10B provides a side view of frame conveying apparatus 1040. FIGS. 10C-E illustrate frame conveying apparatus 1040 transferring an object transportation frame to its storage state.

For frame conveying apparatus 1040, object support platform 710 of elevator 700 moves object transportation frames 400 from object dismounting area 1060 towards frame storage system 1010 after an object is dismounted from the object transportation frames. In frame storage system 1010, the object transportation frames are stored in a vertical manner. From the object storage system, the object transportation frames are moved to frame feed system 1020, where they are reoriented and fed to one of object mounting systems 160.

As seen in FIGS. 10B-D, frame conveying apparatus 1040 operates in conjunction with frame storage system 1010 to orient the object transportation frames for storage. To accomplish this, frame storage system 1010 includes guides 1012 (only one of which is shown here) that direct the object transportation frames from the frame conveying apparatus to the frame storage system.

In operation, once an object has been dismounted from the object transportation frames by object dismounting system 900, the elevator's longitudinal drive system 710 moves the object transportation frames towards frame conveying apparatus 1040. When an object transportation frame arrives at the frame conveying apparatus, the frame conveying apparatus engages the frame. As frame conveying apparatus 1040 moves the object transportation frame, the leading rollers of the object transportation frame engage the leading edge of guides 1012. As the frame conveying apparatus continues to move the frame, the leading rollers follow the guides. Additionally, the leading edges of the guides displace from the proximity of the frame conveying apparatus, FIG. 10C. Thus, the trailing rollers do not engage the guides.

At a predesignated point, the guides prevent further movement of the leading rollers. Thus, as the frame conveying apparatus continues to move the object transportation frame, the object transportation frame is forced to contract, FIG. 10D. After contracting, the object transportation frame disengages from the frame conveying apparatus and moves to a vertical storage orientation, FIG. 10E. The object transportation frame may then be further processed in the frame storage system.

Frame conveying apparatus 1050 may operate similarly to frame conveying apparatus 1040. Frame conveying apparatus 1050, however, is elongated because there is no elevator for object dismounting area 1070. Frame conveying apparatus 1050 conveys the object transportation frames to frame storage system 1010 after the object dismounting system in object dismounting area 1070 dismounts the object from the object transportation frames.

In particular implementations, provisions may be made for routing an incoming object transportation frame to adjacent frame storage systems that are only partially loaded. Additionally, provisions may be made for transferring the object transportation frames to adjacent frame feed systems. Furthermore, frame storage could include a vertical arrangement of frames.

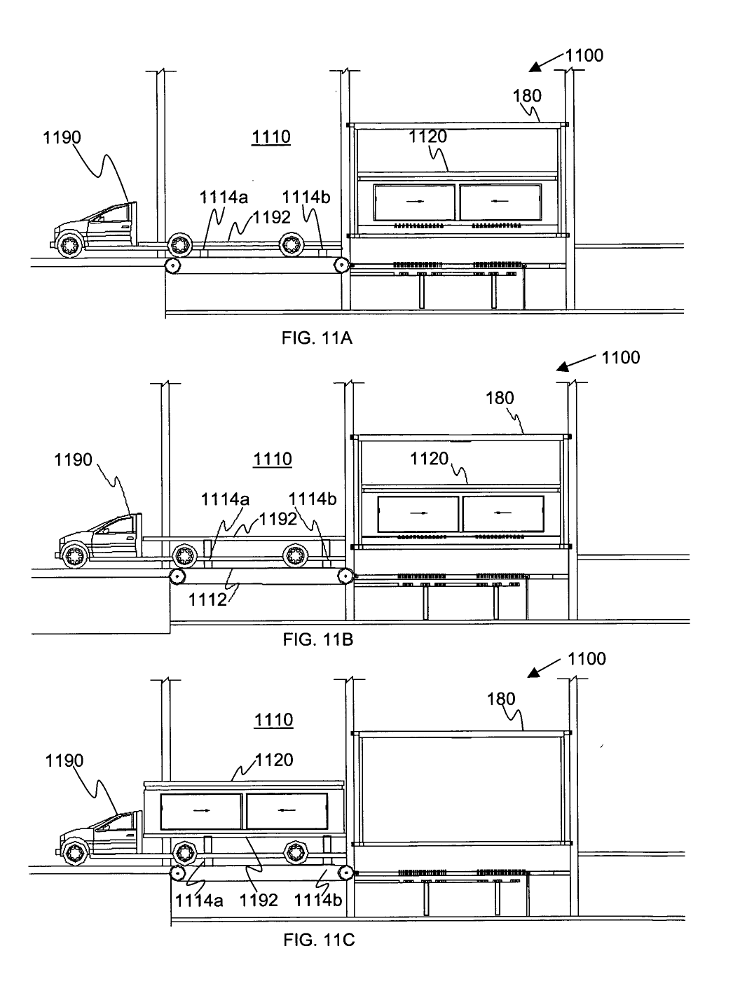

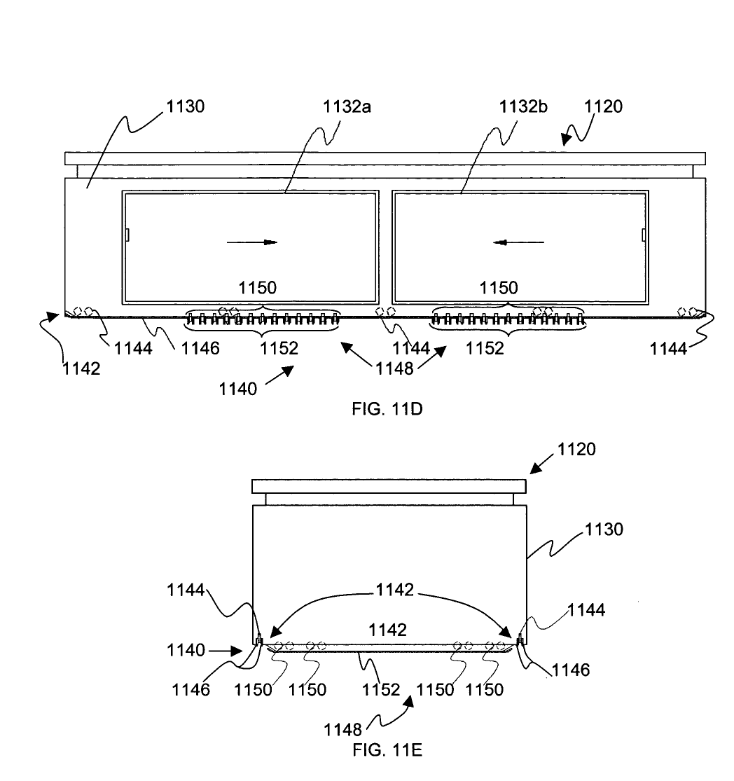

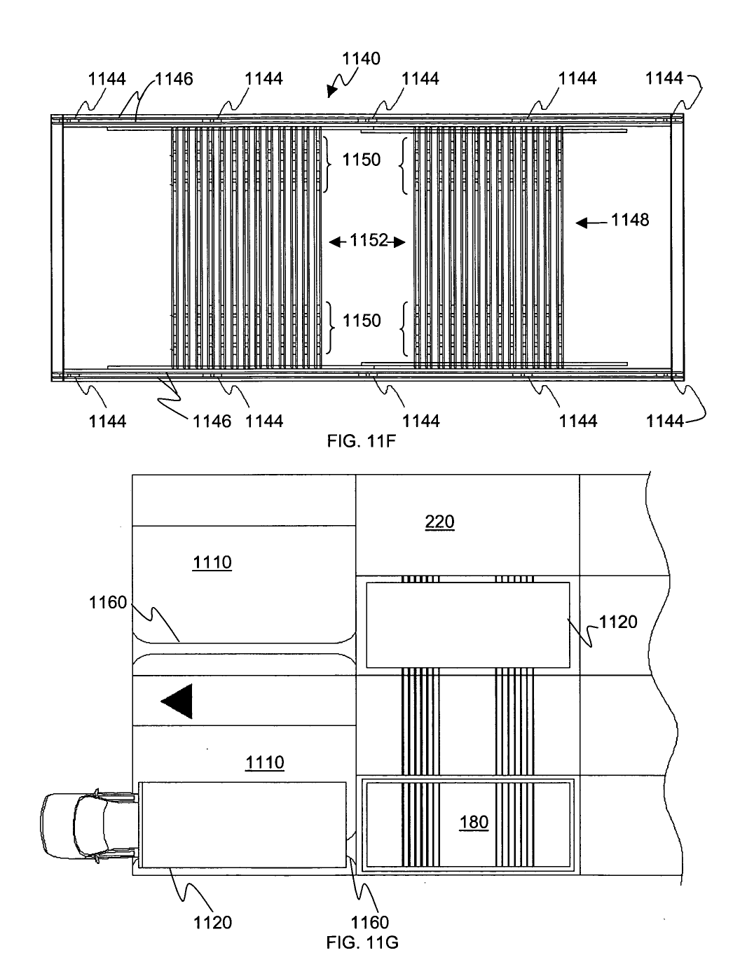

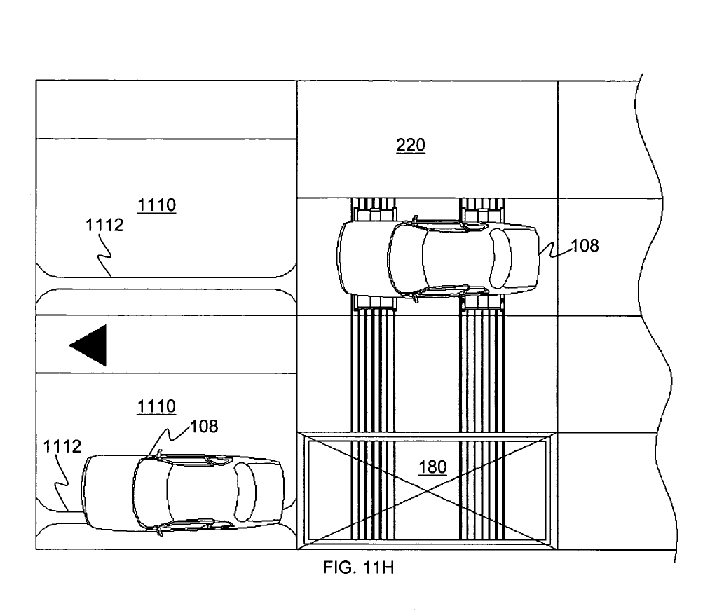

FIGS. 11A-H illustrate another object storage system 1100. Object storage system 1100 is adapted to store a container 1120, another type of transportation object. Container 1120 may be a maritime container, a truck-mounted container, or any other appropriate container. Container 1120 is adapted with an understructure, to be discussed in more detail below, that includes components similar to object transportation frame 400, in order that the container may be transported within the object storage system.

FIGS. 11A-C provide a side view of an object entrance/exit port 1110 and an elevator 180 for system 1100. As illustrated, elevator 180 is transporting a container 1120 for loading at an object entrance/exit port 1110 onto a truck 1190. Note that an object dismounting system is included under the shaft for elevator 180; thus, this implementation may also be used for vehicles or other wheeled transportation objects.

Truck 1190 includes a bed 1192 that supports the container, secures the container to the bed, and raises and lowers the container to the level of elevator 180. The raising and lowering may be facilitated by vertical positioning guides 1114 in object entrance/exit port 1110.

FIG. 11D provides a side view of container 1120, FIG. 11E provides a front view of container 1120, and FIG. 11F provides a bottom view of container 1120. Container 1120 includes a storage compartment 1130. Storage compartment 1130 includes moveable panels 1132 to allow access to the inside of the storage compartment. Container 1120 also includes an understructure 1140. Understructure 1140 may be integral with storage compartment 1130.

Understructure 1140 includes a longitudinal movement system 1142 and a lateral movement system 1148. As illustrated, longitudinal movement system 1142 includes rollers 1144 and sprockets chains 1146 for facilitating longitudinal movement. Lateral movement system 1148 includes rollers 1150 and sprocket chains 1152 for facilitating lateral movement.

In one mode of operation, the storage process begins when truck 1190 carrying container 1120 arrives at object storage system 1100. The truck backs into object entrance/exit port 1110 until it aligns with vertical positioning guides 1114. Then, the container is raised. Once the level of the truck bed is at the same level as the elevator, the container is moved into the elevator, by a drive system in the bed.

Elevator 180 may include a longitudinal drive system and a lateral drive system similar to longitudinal drive system 720 and lateral drive system 730 in FIG. 7A. Thus, once container 1120 enters elevator 180, the longitudinal drive system can finish transferring and positioning the container for transport. The elevator then transports the container to the appropriate level and transfers the container to a transfer carriage system, which may be similar to transfer carriage system 185, FIG. 1C. The transfer carriage system moves the container to the appropriate storage bay.

The retrieval of the container from the storage bay proceeds in a generally inverse manner. The unloading of the object from the elevator may be accomplished by using a longitudinal drive system of the elevator to move the object outwardly until a drive system of the truck is engaged. The truck can then finish loading the object.

In particular implementations, the container may not leave the object storage facility when retrieved. For example, upon retrieval, the container may be placed at the disposal of the custodian for the purpose of adding and/or removing contents from the container. Subsequently, the container is returned to its storage bay by inverting the above sequence.

FIGS. 11G-H illustrate object entrance/exit ports for such an implementation. As illustrated, a container may be unloaded from elevator 180 in a longitudinal or lateral direction. If in the longitudinal direction, the container is unloaded to a truck in object entrance/exit port 1110. If in the lateral direction, the container is conveyed laterally to align with another object entrance/exit port 1110. At this position, however, the object may be accessed through room 220, which is one example of an object access location. In other implementations, access may be had through other rooms or in other areas of the object storage system.

FIGS. 11G-H also illustrate another feature of an object exit port. As shown, object entrance/exit ports 1110 include a guide 1160. Guide 1160 ensures that a vehicle exits the elevator in a controlled manner. Guide 1160 may be a channel cut in a platform, a pair of rails, or any other appropriate directing apparatus. Guide 1160 may include a detent (e.g., a raised area or a depressed area) to ensure that an object stops at the appropriate location.

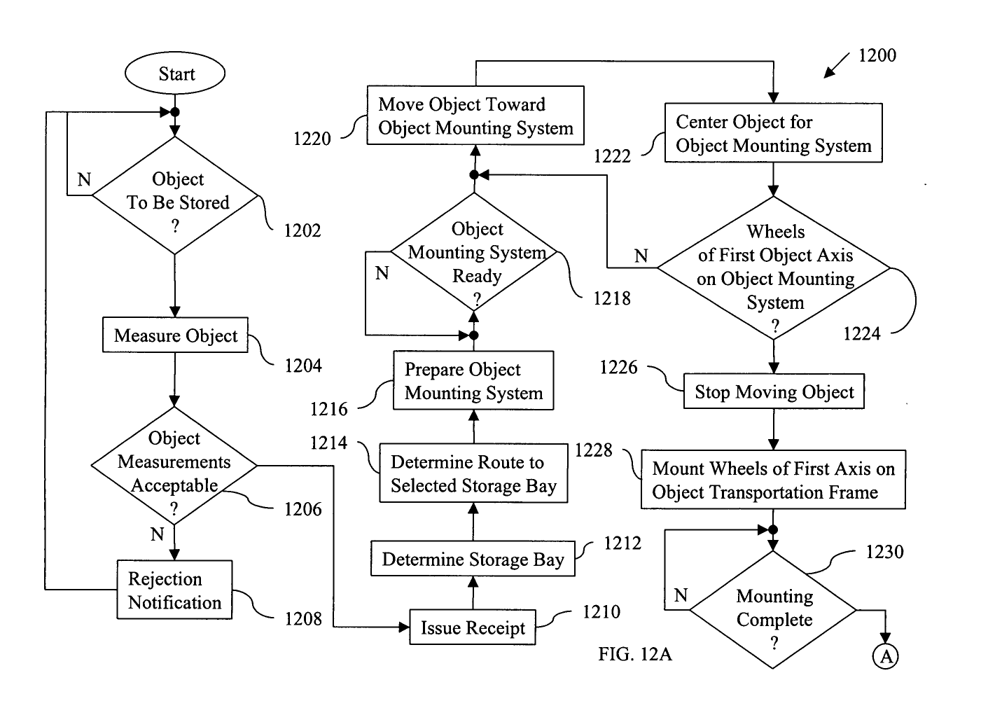

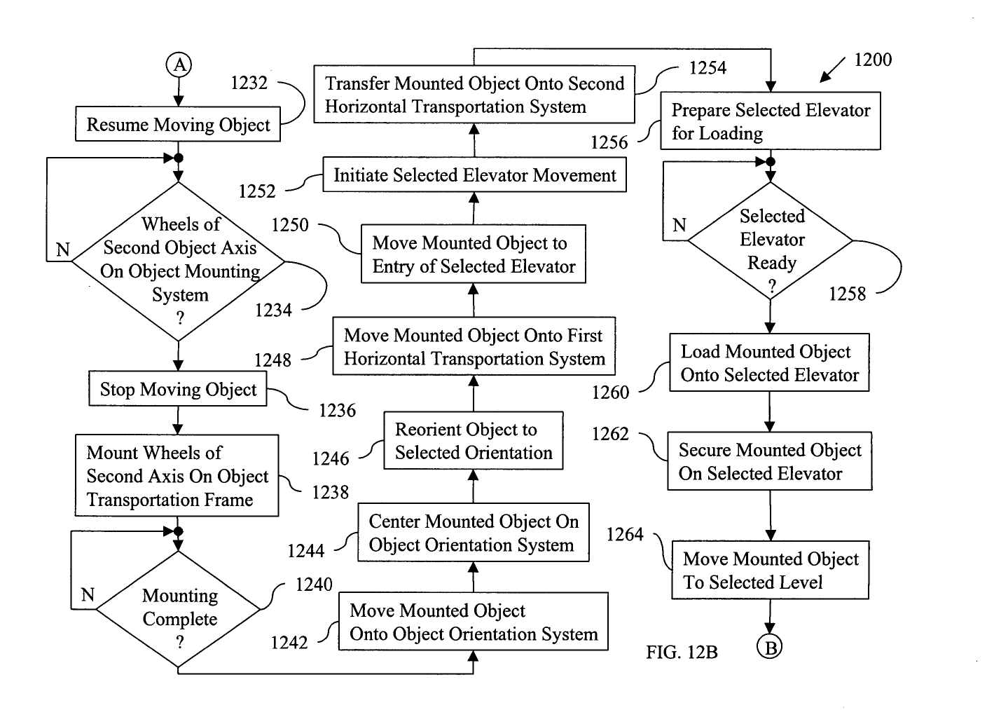

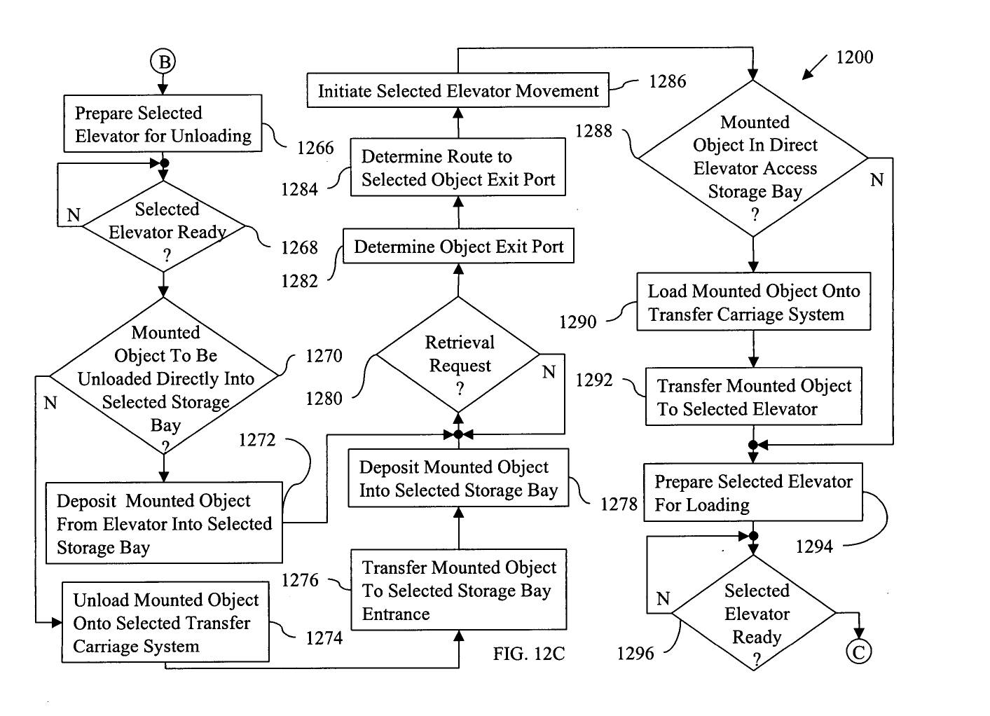

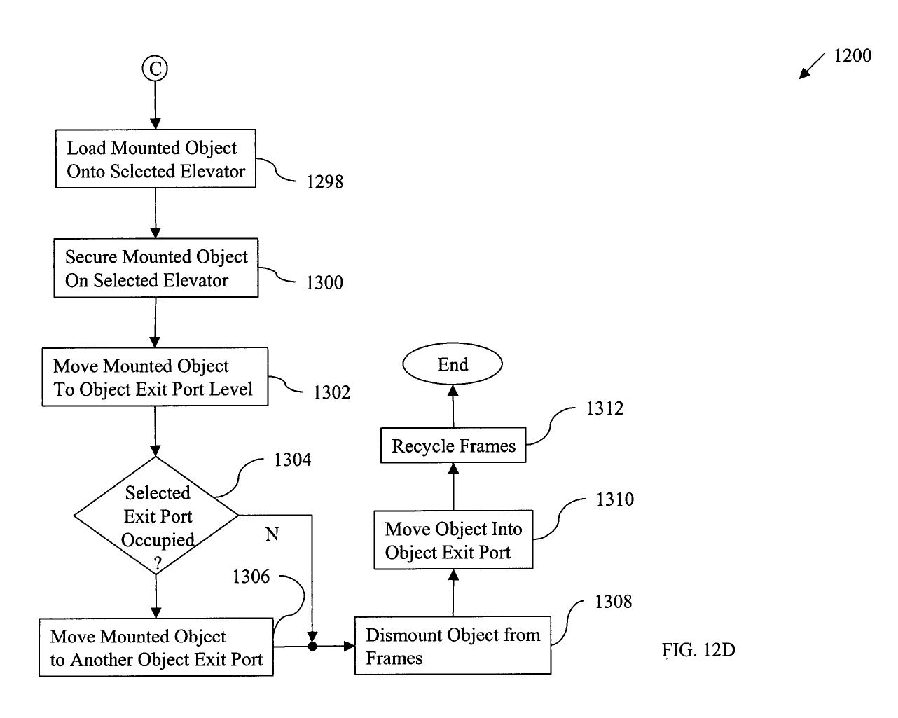

FIGS. 12A-D illustrate a process 1200 for storing objects. Process 1200 may, for example, represent the operations of an object storage system similar to object storage system 100 in FIG. 1.

Process 1200 begins with waiting for an object to be stored to arrive (decision block 1202). Determining whether an object to be stored has arrived may, for example, be accomplished by detecting a signal indicating that there is an object in an object entrance port.

Once an object to be stored has arrived, the process calls for measuring (e.g., size and weight) the object (function block 1204). The measurement(s) may, for example, be performed by a platform in the object entrance port. Once the object measurements are performed, the process calls for determining whether the object measurements are acceptable (function block 1206). Object measurements may, for example, be acceptable if they fall within a predesignated range. If the object measurements are unacceptable, the process calls for generating a rejection notification (function block 1208) and waiting for another object to be stored (decision block 1202). The rejection notification may be in an audible, visual, or other appropriate format. If, however, the object measurements are acceptable, the process continues with issuing a receipt for the object custodian (function block 1210). The object custodian may then leave the object. The receipt may, for example, include the time, the date, and object identification information. Determining that an object receipt has been issued is one example of determining that an object is to be moved.

The process then continues with preparing to move the object. The process calls for determining a storage bay for the object (function block 1212). Determining a storage bay may be based on one of more factors, such as, for example, the current distribution of objects stored in the facility, the objects currently being processed by the facility, the anticipated object storage time, and the anticipated object exit port. The process also calls for determining a route to the selected storage bay (function block 1214). Determining a route may, for example, include selecting an elevator. One or both of the determinations may factor in the object storage systems movements already underway and those that have already been scheduled. Also, the determinations may be made by optimizing for one or more metrics, such as, for example, routing time, power consumption, and storage bay occupancy.

The process continues with preparing an object mounting system (function block 1216). Preparing an object mounting system may, for example, include providing an object transportation frame to the object mounting system, having the object mounting system position the frame, and having the object mounting system prepare (e.g., expand) the frame. The process also calls for waiting until the object mounting system is ready (decision block 1218).

Once the object mounting system is ready, the process calls for moving the object toward the object mounting system (function block 1220). The object may, for example, be moved by a chain-driven roller system. The process also calls for centering the object for the object mounting system (function block 1222). The centering may, for example, be performed by a system similar to object aligning system 300. The process additionally calls for determining whether the wheels of a first object axis are on the object mounting system (decision block 1224). If the wheels of the first object axis are not on the object mounting system, the process calls for continuing to move the object toward the object mounting system (function block 1220) and centering the object (function block 1222).

Once the wheels of the first axis are on the object mounting system, movement of the object is stopped (function block 1226). Then, the wheels of the first axis are mounted on an object transportation frame (function block 1228). The object transportation frame may, for example, be similar to object transportation frame 400, and the mounting sequence may be similar to that described for object mounting system 500. The process calls for waiting until the mounting is complete (decision block 1230).

Once the mounting is complete, the process continues with resuming movement of the object (function block 1232) and waiting for the wheels of a second object axis to be on the object mounting system (decision block 1234). Once the wheels of the second object axis are on the object mounting system, movement of the object is stopped (function block 1236). The process then calls for mounting the wheels of the second axis on an object transportation frame (function block 1238). The process also calls for waiting until the mounting is complete (decision block 1240).

Once the mounting is complete, the process call for moving the mounted object onto an object orientation system (function block 1242) and centering the mounted object on the object orientation system (function block 1244). The object is then reoriented to a selected orientation (function block 1246). As discussed previously, this orientation may have been previously determined based on the object's anticipated exit port.

After reorientation, the process calls for moving the mounted object onto a first horizontal transportation system (function block 1248) and moving the mounted object to the entrance of a selected elevator (function block 1250). The elevator may, for example, have been selected during the routing determination (function block 1214). The process also calls for initiating elevator movement toward the mounted object (function block 1252) and transferring the mounted object onto a second horizontal transportation system (function block 1254). The transfer may, for example, be accomplished by a ramping system that intermeshes the two horizontal transportation systems. The second horizontal transportation system may be used to load the mounted object on the elevator.

The process continues with preparing the selected elevator for loading (function block 1256). Preparing the selected elevator for loading may include positioning the elevator, securing the elevator, and/or any other appropriate function. In certain implementations, securing the elevator may include decoupling an object support platform of the elevator from the rest of the elevator. The process also calls for waiting for the selected elevator to be ready for loading (decision block 1258).

Once the selected elevator is ready, the process calls for loading the mounted object onto the selected elevator (function block 1260). The movement may, for example, be accomplished by the second horizontal transportation system and an elevator drive system. The process also calls for securing the mounted object on the selected elevator (function block 1262) and moving the mounted object to the selected level (function block 1264). Securing the mounted object may, for example, be accomplished by engaging an elevator drive system with the mounted object.

Once the mounted object is at the selected level, the process continues with preparing the selected elevator for unloading (function block 1266). Preparing the selected elevator for unloading may, be similar to preparing the selected elevator for loading. The process also calls for determining whether the selected elevator is ready for unloading (decision block 1268). If the selected elevator is ready, the process calls for determining whether the mounted object is to be unloaded directly into the selected storage bay from the elevator (decision block 1270). If the mounted object is to be unloaded directly into the selected storage bay, the mounted object is deposited from the elevator into the selected storage bay (function block 1272). If, however, the mounted object is not to be unloaded directly into a storage bay from the elevator, the process calls for unloading the mounted object onto a selected transfer carriage system (function block 1274) and transferring the mounted object to the entrance of the selected storage bay (function block 1276). The process also calls for depositing the mounted object into the selected storage bay (function block 1278). Depositing the mounted object may, for example, be accomplished by horizontally transferring the mounted object into the selected storage bay.

The process then calls for waiting for a retrieval request for the object (decision block 1280). The retrieval request may, for example, occur when an object custodian returns, presents the issued receipt, and pays an appropriate fee. Determining that a retrieval request has been received is one example of determining that an object is to be moved.

The process continues with preparing to move the requested object. The process calls for determining an object exit port (function block 1282). Determining an object exit port may include ascertaining a previously selected object exit port, analyzing the current use of object exit ports, analyzing the expected use of object exit ports, and/or any other appropriate analysis. The process also calls for determining a route to the selected object exit port (function block 1284). Determining a route to the selected object exit port may, for example, include selecting an elevator.

The process continues with initiating movement of the selected elevator toward the mounted object's storage level (function block 1286) and determining whether the mounted object is in a storage bay that may be directly accessed from the selected elevator (decision block 1288). If the mounted object is not in a storage bay that may be directly accessed from the selected elevator, the process calls for loading the mounted object onto a transfer carriage system (function block 1290) and transferring the mounted object to the selected elevator (function block 1292).

Once the mounted object is being transferred to the selected elevator, or if the mounted object is in a storage bay that may be directly accessed from the selected elevator, the process calls for preparing the selected elevator for loading (function block 1294). Preparing the selected elevator may, for example, include positioning and securing the elevator. The process also calls for waiting for the selected elevator to be prepared (decision block 1296).

Once the selected elevator is prepared, the process continues with loading the mounted object onto the selected elevator (function block 1298) and securing the mounted object on the selected elevator (function block 1300). The mounted object may then be moved to the object exit port level (function block 1302).

The process continues with determining whether the selected object exit port is occupied (decision block 1304). If the selected object exit port is occupied, the process calls for moving the mounted object to another object exit port (function block 1306). This may, for example, be accomplished with a horizontal transportation system.

If the selected object exit port is not occupied, or if the object has been moved to another object exit port, the process calls for dismounting the object from the frames (function block 1308). Dismounting the object from the frames may, for example, be performed in a similar manner to mounting the object on the frames. The object is then moved into the object exit port (function block 1310), and the object custodian may then access the object. The process also calls for recycling the frames (function block 1312).

Although FIG. 12 illustrates one implementation of a process for object storage, other processes for object storage may include fewer and/or additional operations. For example, a process may include coding and tagging an object. As another example, a process may include tracking an object's position. As a further example a process may not include mounting an object on an object transportation frame. For instance, a pallet or other appropriate object transportation apparatus may be used for transporting an object, or objects with integrated movement understructures may be used. As an additional example, a process may not include reorienting an object. This may, for instance, occur if the object orientation at the object entrance port is the same as the object orientation at the object exit port or if orientation does not matter. As another example, a process may not include moving a mounted object to the entry of an elevator. This may, for instance, occur if an elevator is adjacent the object mounting system or if the object is received directly into an elevator. As a further example, an object may not have to be transferred between horizontal transportation systems. As an additional example, a process may call for replacing one or more of the waiting operations with an event determination operation (e.g., replacing waiting for an object to be stored to arrive with determining whether an object to be stored has arrived). The event determinations may, for instance, be performed by receiving an appropriate signal from a sensor or receiving a signal indicating that an operation is complete. Furthermore, one or more operations may include waiting for an event to occur before executing the operation.

Additionally, various operations in FIG. 12 may be performed in any order. For example, determining a storage bay and/or a route to a storage bay may be performed after mounting the object on object transportation frames, after reorienting the object, or at any other appropriate time. As another example, initiating movement of the selected elevator for storing the object may occur after mounting the object on the object transportation frames, after reorienting the object, or at any other appropriate time. As an additional example, determining the object exit port and the route thereto may be determined when the object is received, when the object is stored, or at any other appropriate time.

Various operations in FIG. 12 may be also be performed simultaneously. For example, the storage bay and the storage route may be determined while the object is being mounted on the object transportation frames, while the object is being reoriented, or during any other appropriate operation. As another example, the elevator may be moved and/or prepared for loading while the object is being mounted on the object transportation frames, reoriented, or moved to the elevator entrance. As an additional example, the transfer carriage system may be moved while the object is being moved to the selected level, while the elevator is being prepared for unloading, or at any other appropriate time.

Furthermore, operations for other objects may being occurring contemporaneously. Thus, operations such as measuring an object, determining a storage bay and storage route, mounting an object, reorienting an object, moving an object to an elevator entrance, loading an object, moving an object to a selected level, and depositing the object in a storage bay may be interspersed with and/or simultaneously executed with similar operations for other objects.

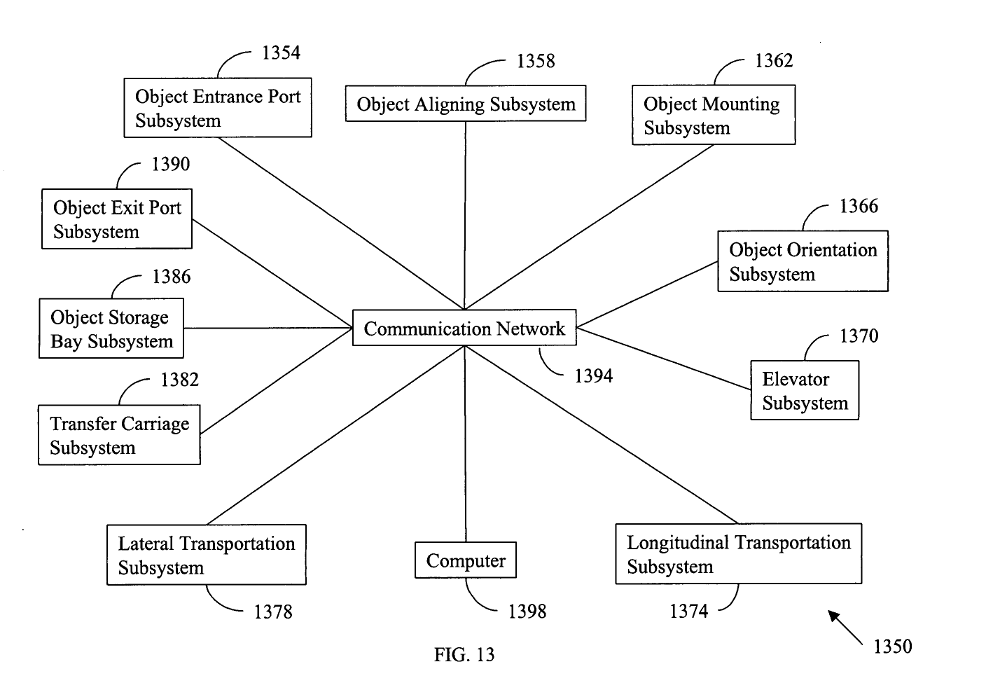

FIG. 13 illustrates an example network 1350 of components for controlling an object storage system. As illustrated, network 1350 includes an object entrance port subsystem 1354, an object aligning subsystem 1358, an object mounting subsystem 1362, an object orientation subsystem 1366, an elevator subsystem 1370, a longitudinal transportation subsystem 1374, a lateral transportation subsystem 1378, a transfer carriage subsystem 1382, an object storage bay subsystem 1386, and an object exit port subsystem 1390. Each of subsystems 1354-1390 may include various sensors for sensing the presence of an object, the position of an object, data about an object, and/or the state of the subsystem. For example, position detection may be accomplished by using optical sensors, such as, for example, photo diodes, photo cells, motion detectors, or lasers, audio sensors, visual sensors, such as, for example, cameras, or mechanical sensors, such as, for example, load cells, strain gauges, or trip levers.

Also, subsystems 1354-1390 may include various actuators for manipulating an object or components of the object storage system. The actuators may include motors, pistons, relays, and/or any other appropriate force producing device. The force produced by an actuator may be transmitted by links, transmissions, rams, or any other appropriate force conveyance device. Power may be supplied to the actuators in any appropriate manner. In particular implementation, power may be supplied to a number of components by a prime mover. The prime mover may produce power based on the consumption of electricity, fuel, or other appropriate energy source.

Subsystems 1354-1390 may additionally include various controllers for managing various operations of the subsystems. Examples of controllers include programmable logic arrays, microcontrollers, and microprocessors. The controllers may function independently of or in conjunction with a central computer. Note that subsystems 1354-1390 may also allow for the interaction of humans to provide at least some data and/or control.

Subsystems 1354-1390 are coupled to a communication network 1394. Communication network 1394 may, for example, operate according to IEEE 802.3. Communication network 1394 is responsible for conveying data between subsystems 1354-1390 and between the subsystems and a computer 1398. For example, subsystems that operate in sequence may communicate with each other to pass an object therebetween. Additionally, computer 1398 may control one or more aspects of each of subsystems 1354-1390.

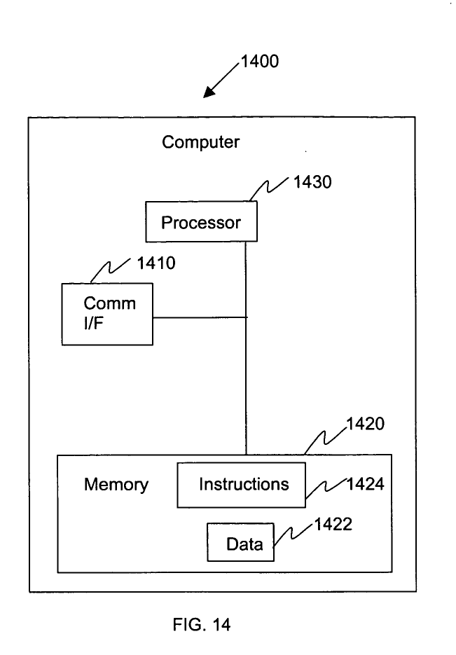

FIG. 14 illustrates an example computer 1400. Computer 1400 may be similar to computer 1398 in FIG. 13.

Computer 1400 includes a communication interface 1410, memory 1420, and a processor 1430. Communication interface 1410 is responsible for receiving data from and sending data to various subsystems of an object storage system. Communication interface may, for example, be a network interface card (NIC). Memory 1420 may include random access memory (RAM), read-only memory (ROM), compact-disk read-only memory (CD-ROM), flip-flops, and/or any other appropriate information storage device. Memory 1420 includes data 1422 and instructions 1424. Data 1422 may include information received from various subsystems about the state of an object and/or about the state of the subsystems. Instructions 1424 provide the logical operations for processor 1430. Processor 1430 may be a reduced-instruction set computer (RISC), a complex instruction set computer (CISC), or any other appropriate device for logically manipulating information. Processor 1430 may operate according to instructions 1424 in memory 1420. In certain implementations, some or all of the instructions may be encoded on processor 1430. Also, processor 1430 may be a special-purpose processor (e.g., a microcontroller or a field programmable gate array (FPGA)). The instructions may inform processor 1430 how to determine operation sequences of and perform administrative functions for an object storage system. For example, the instructions may allow the processor to control operations similar to those in process 1200. The operations may be controlled by receiving data regarding one or more subsystems and objects and issuing one or more commands. Furthermore, the instructions may allow the computer to simultaneously control operations for a variety of subsystems of an object storage system. The instructions may also provide for generating a graphical user interface that illustrates the object storage system, its occupancy, and the status of the subsystems. The graphical user interface may be conveyed to a remote user interface device, such as, for example, a personal computer (PC) or a personal digital assistant (PDA).

In certain implementations, the instructions may include a supervisor and command subsystem, a human interfacing subsystem, and an administrative subsystem. The human interfacing subsystem is responsible for providing bi-directional communication with a system operator, and the administrative subsystem is responsible for performing contracting and billing for stored objects. The instructions may also include an alarm sequencing subsystem, a fault isolation subsystem, and a motion control subsystem. The motion control subsystem may include a storage object routing subsystem, a retrieval object routing subsystem, a recognition and surveillance subsystem, a queuing operation subsystem, and a movement drive command subsystem.

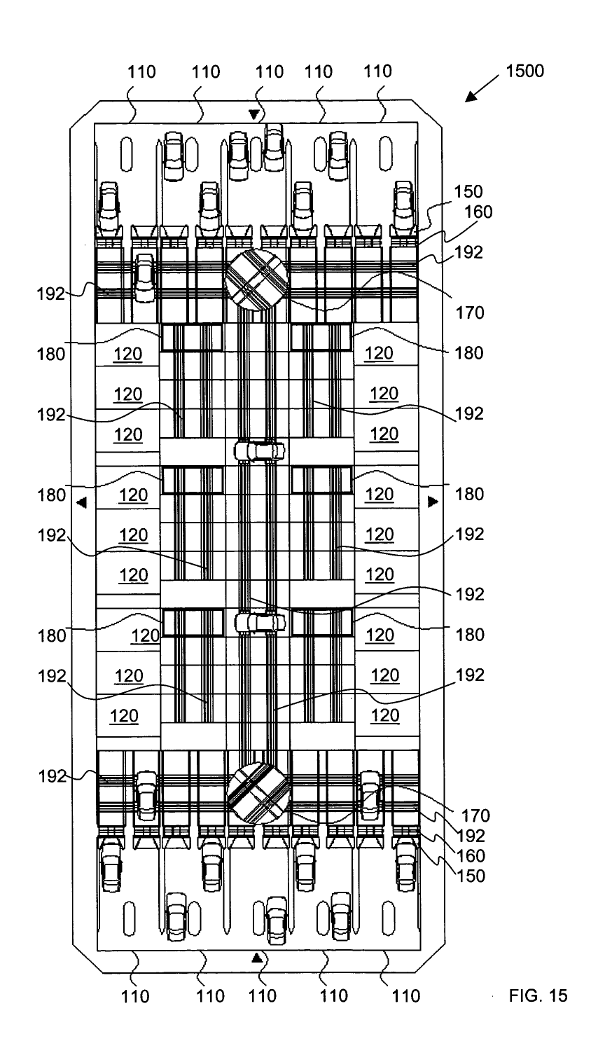

FIG. 15 illustrates an object storage system 1500. In general, object storage system 1500 may be similar to object storage system 100. One difference, though, is that object storage system 1500 includes a number of lateral object entrance ports 110 at both its lateral ends and longitudinal object exit ports 120 at both longitudinal ends. Also, due to having object entrances at its lateral ends, object storage system 1500 has two object orientation systems 170. Like object storage system 100, however, object storage system 1500 also includes object aligning systems 150, object mounting systems 160, elevators 180, and lateral transportation systems 192.

In operation, object storage system 1500 functions similarly to object storage system 100. However, because object exit ports 120 are on both lateral sides of system 1500, coordination needs to be maintained between the storage orientation of the objects and object exit ports 120 if the objects are to exit in a forward manner. In particular implementations, at the time of acceptance, the object custodian may be instructed as to which side of the system the object will be delivered upon return.

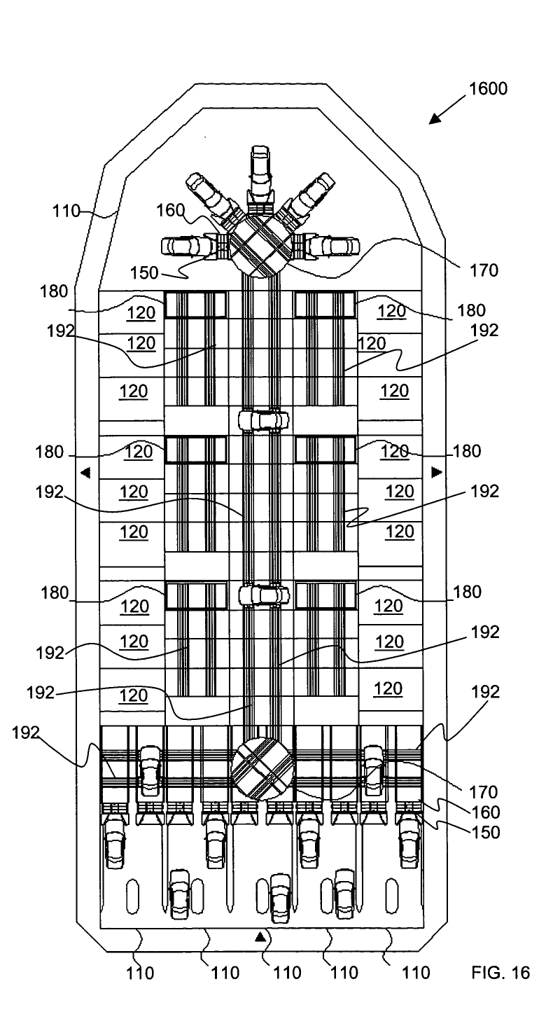

FIG. 16 illustrates an object storage system 1600. Object storage system 1600 may be similar to object storage system 1500. Object storage system 1600 includes entrance ports 110 at its lateral ends and longitudinal object exit ports 120 at both longitudinal ends. One of object entrance ports 110, however, is circular. Due to having object entrances at its lateral ends, object storage system 1600 has two object orientation systems 170. Also, the need to transfer a mounted object from object mounting systems 160 to one of object orientation systems 170 has been eliminated at this end. Object storage system 1600 additionally includes object aligning systems 150, object mounting systems 160, elevators 180, and lateral transportation systems 192.

In operation, object storage system 1600 functions similarly to object storage system 100. However, because object exit ports 120 are on both lateral sides of system 1600, coordination needs to be maintained between the storage orientation of the objects and object exit ports 120 if the objects are to exit in a forward manner.

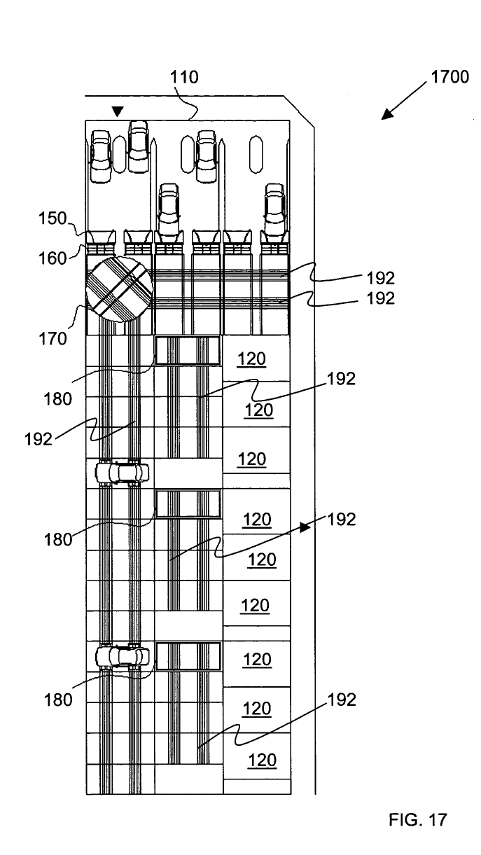

FIG. 17 illustrates an object storage system 1700. In general, object storage system 1700 may be similar to object storage system 100. One difference, though, is that object storage system 1700 includes a number of lateral object entrance ports 110 at one of its lateral ends. Like object storage system 100, however, object storage system 1700 also includes object aligning systems 160, object mounting systems 160, elevators 180, and lateral transportation systems 192. In operation, object storage system 1700 functions similarly to object storage system 100.

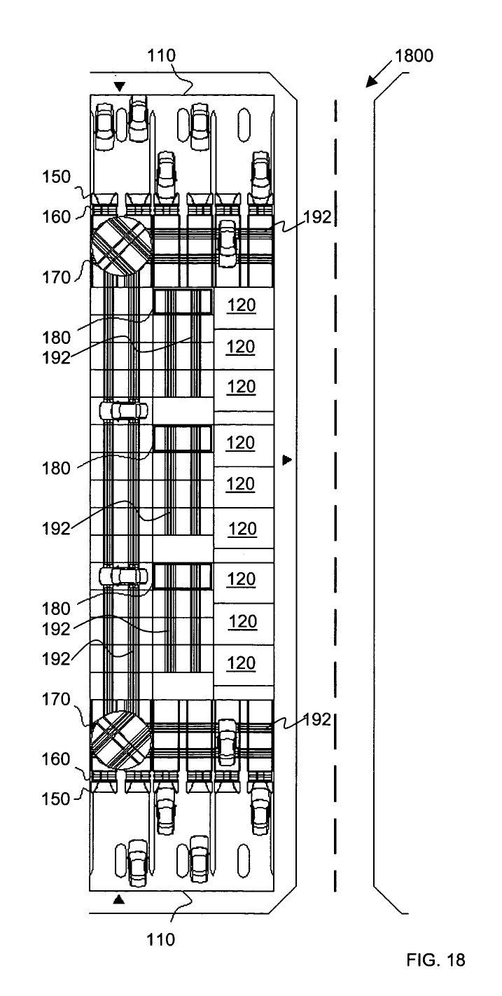

FIG. 18 illustrates an object storage system 1800. In general, object storage system 1800 may be similar to object storage system 100. One difference, though, is that object storage system 1800 includes a number of lateral object entrance ports 110 at both of its lateral ends. Like object storage system 100, however, object storage system 1800 also includes object aligning systems 150, object mounting systems 160, elevators 180, and lateral transportation systems 192, and longitudinal object exit ports 120. In operation, object storage system 1700 functions similarly to object storage system 100.

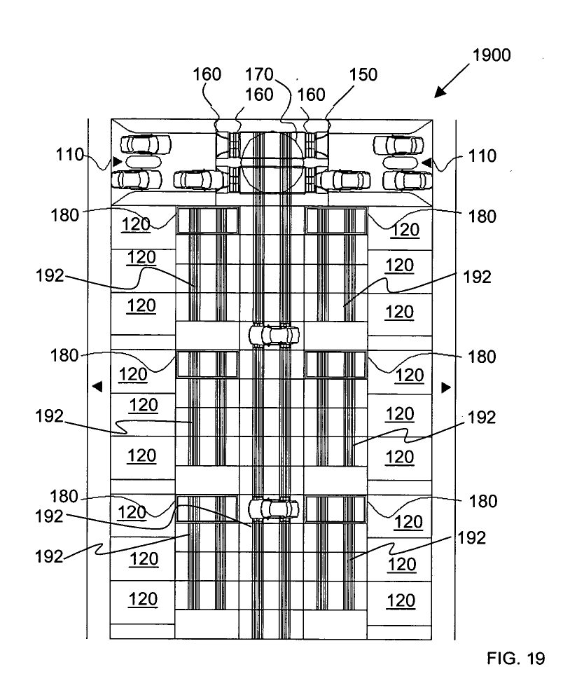

FIG. 19 illustrates an object storage system 1900. In general, object storage system 1900 may be similar to object storage system 100. One difference, though, is that object storage system 1900 includes two longitudinal object entrance ports 110 at one lateral end and longitudinal object exit ports 120 at both longitudinal ends. Like object storage system 100, however, object storage system 1900 also includes object aligning systems 150, object mounting systems 160, an object orientation system 170, elevators 180, and lateral transportation systems 192.

In operation, object storage system 1900 functions similarly to object storage system 100. However, because object exit ports 120 are on both lateral sides of system 1200, coordination needs to be maintained between the storage orientation of the objects and object exit ports 120 if the objects are to exit in a forward manner.

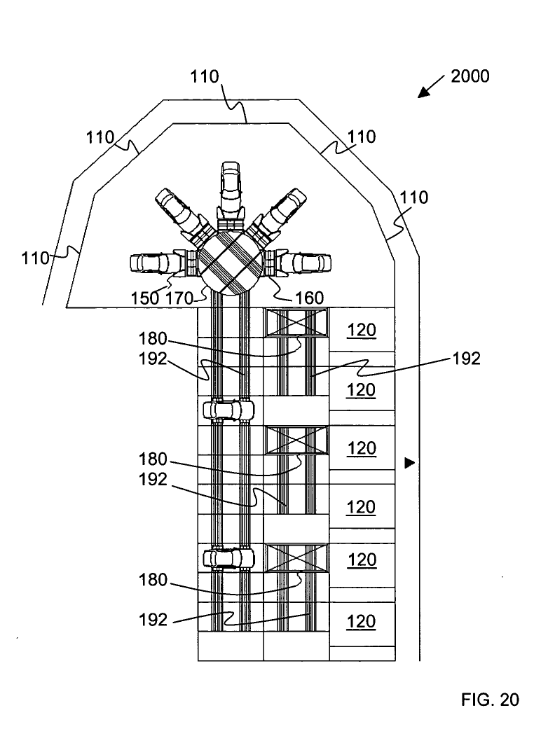

FIG. 20 illustrates an object storage system 2000. In general, object storage system 2000 may be similar to object storage system 100. One difference, though, is that object storage system 2000 includes a circular object entrance port 110 at one lateral end. Also, this configuration eliminates the need for a transportation system to move the mounted object to object orientation system 170. Like object storage system 100, however, object storage system 2000 also includes object aligning systems 150, object mounting systems 160, elevators 180, and lateral transportation systems 192. In operation, object storage system 2000 functions similarly to object storage system 100.

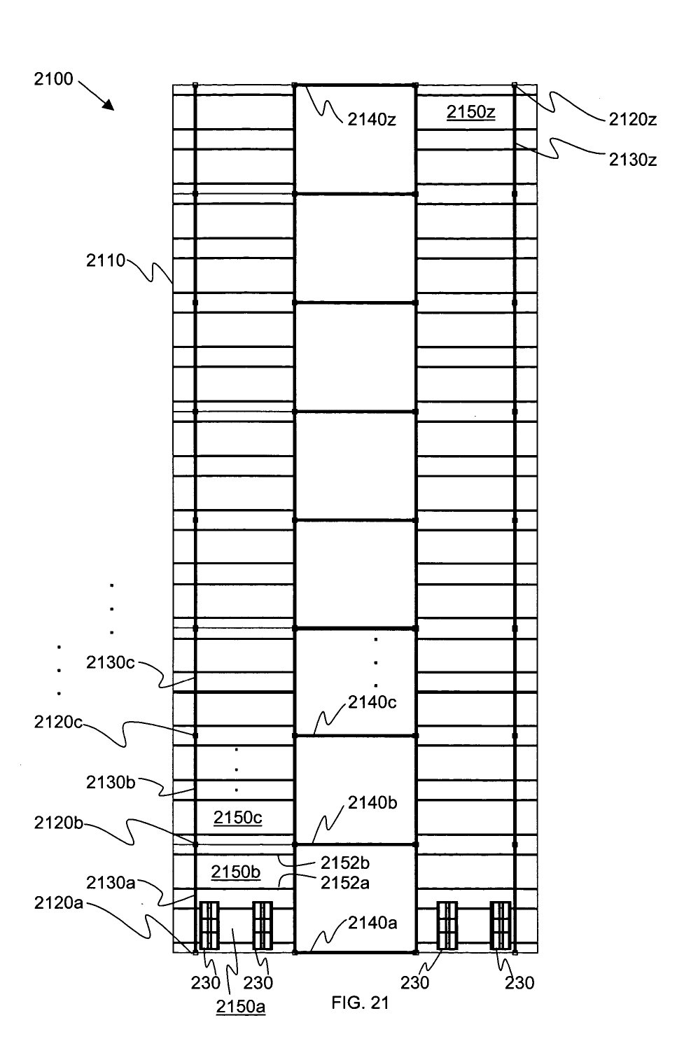

FIG. 21 illustrates an object storage system 2100. In general, object storage system 2100 may be similar to object storage system 100. Object storage system includes an outer walls 2110, vertical supports 2120, horizontal supports 2130, horizontal supports 2140, and storage bays 2150.

Outer walls 2110 may protect stored objects from debris, environmental conditions (e.g., rain, hail, dust, etc.), and/or vandalism. Outer walls 2110 may be solid, perforated, mesh, or any other appropriate configuration and may be made of steel, aluminum, plastic, or any other appropriate material. Outer walls 2110 may or may not be loading bearing.

Vertical supports 2120, horizontal supports 2130, and horizontal supports 2140 may be columns, girders, beams, or any other appropriate load bearing members. The supports may be made of concrete (pre-tensioned, post-tensioned, or non-tensioned), steel, or any other appropriate material.

As illustrated, vertical supports 2120 and horizontal supports 2130 are set in from walls 2110a and 2110c. This locates these supports nearer the weight application points of the objects stored in storage bays 2150. Thus, this may result in a reduced size for the supports and, hence, a reduction in overall object storage system weight. Also, only two of horizontal members are needed for every four storage bays 2150, which may also allow for reduced overall storage system weight.

Each of storage bays 2150 has two guides 2152 for supporting object transportation frames 230. Storage bays 2150 may or may not have floors and/or ceilings. Guides 2152 also benefit from vertical supports 2120 and horizontal supports 2130 being set in from walls 2110a and 2110c. By locating the supports in from these walls, guides 2152 have reduced spans. Thus, the guides may be smaller and still support the same amount of weight.

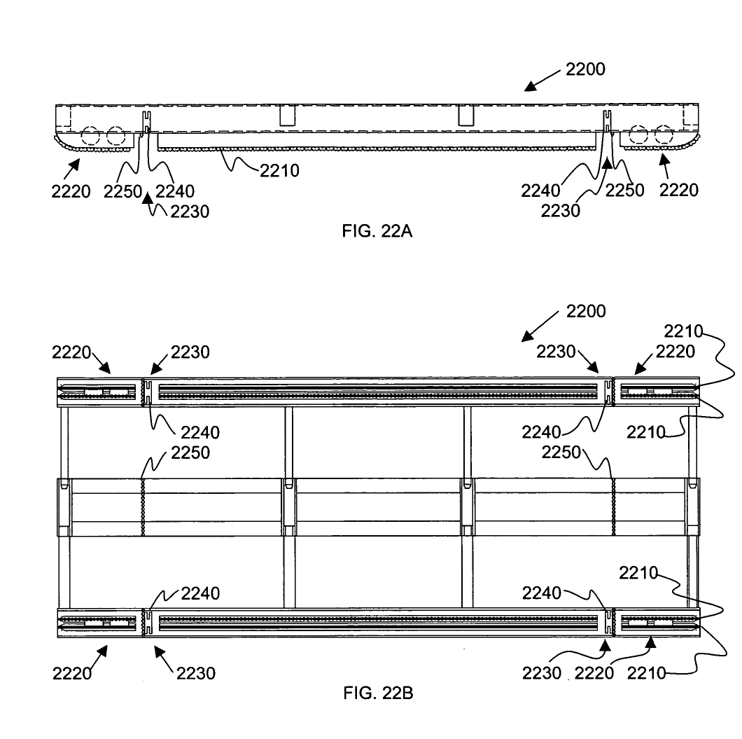

FIGS. 22A-B illustrate an object transportation frame 2200. Object transportation frame 2200 may be useful in object storage system 2100. In general, object transportation frame 2200 may be similar to object transportation frame 230.

As illustrated, object transportation frame 2200 includes sprocket chains 2210 and rollers 2020 to provide lateral movement for a mounted object. Also, object transportation frame 2200 includes notches 2230 in sprocket chain 2210. Located in notches 2230 are rollers 2240 and sprocket chains 2250, which provide longitudinal movement for a mounted object.

Several implementations for object storage have been discussed in detail. Various alternative implementations have also been mentioned or suggested. Furthermore, a variety of additions, deletions, substitutions, and transformations may be made to these implementations while still achieving object storage. The invention, therefore, is to be measured by the appended claims.

1. An object storage system, the object storage system comprising:
a multi-level structure for storing objects mounted on frames, the structure comprising:
a port to receive incoming objects,
a plurality of object storage levels comprising frame mounted object storage bays, and
a port to release departing objects;
an elevator to move frame mounted objects between levels; and
a transfer carriage system on each object storage level to receive frame mounted objects from the elevator, move frame mounted objects between the elevator and at least some of an object storage level's storage bays, and horizontally deposit frame mounted objects in the storage bays.

2. The system of claim 1, wherein the elevator comprises:
a first drive system operable to engage a frame mounted object and move it along a first axis; and
a second drive system operable to engage a frame mounted object and move it along a second axis.

3. The system of claim 2, wherein a frame mounted object may be unloaded along either the first axis or the second axis on an object storage level.

4. The system of claim 1, wherein the elevator comprises an object support platform to receive a frame mounted object, the object support platform operable to be coupled to an elevator shaft while receiving a frame mounted object.

5. The system of claim 4, wherein the elevator comprises a cage, the cage operable to be decoupled from the object support platform while receiving a frame mounted object.

6. The system of claim 1, further comprising a plurality of elevators.

7. The system of claim 6, wherein more than one of the elevators may be used for moving an incoming object to one of the object storage levels.

8. The system of claim 6, wherein more than one of the elevators may be used for moving a departing object to the object release port.

9. The system of claim 6, further comprising a plurality of transfer carriage systems on each object storage level.

10. The system of claim 9, wherein adjacent transfer carriage systems are operable to exchange a frame mounted object across an elevator shaft.

11. The system of claim 1, further comprising a horizontal transportation system for moving a frame mounted object between the object receiving port and the elevator.

12. The system of claim 11, further comprising a plurality of object transportation frames, the object transportation frames operable to be mounted independently of each other to an object for support and facilitating movement in the object storage system.

13. The system of claim 12, wherein the horizontal transportation system comprises a guide set for each object transportation frame of a frame mounted object, each guide set comprising a plurality of guides, wherein an object transportation frame may be conveyed on different guides in a guide set depending on the size of an object.

14. The system of claim 12, wherein an object transportation frame is operable to expand to receive an object's wheels on a first object axis and to contract to engage the wheels.

15. The system of claim 12, wherein an object transportation frame comprises rollers that allow the frame to move along two axes.

16. The system of claim 12, further comprising an object mounting system, the object mounting system operable to mount an object on an object transportation frame.

17. The system of claim 16, further comprising a frame recycling system, the recycling system operable to receive frames at the object release port and to convey them to the object mounting system.

18. The system of claim 11, wherein the horizontal transportation system comprises a subsystem for moving a frame mounted object along one axis and a subsystem for moving a frame mounted object along another axis.

19. The system of claim 18, wherein the horizontal transportation system comprises an axis transfer subsystem operable to transfer the frame mounted object between the axial transportation subsystems.

20. The system of claim 19, wherein the axis transfer subsystem comprises:
a cam drive system;
a ramping cam; and
a cam following apparatus coupled to one of the axial transportation subsystems.

21. The system of claim 18, wherein the horizontal transportation system is operable to center a frame mounted object for at least one of the axial transportation systems based on the outer dimensions of the object.

22. The system of claim 1, wherein the object receiving port comprises an object measuring system, the object measuring system operable to determine the weight and dimensions of an object.

23. The system of claim 1, further comprising an object aligning system, the object aligning system operable to align the longitudinal centerline of the object.

24. The system of claim 23, wherein the object aligning system comprises:
a pair of parallel arms; and
a centering compensation apparatus coupled to the arms, the apparatus allowing the arms to move apart in parallel relation to each other while supplying a restoring force to the arms.

25. The system of claim 1, further comprising an object orientation system located between the object receiving port and the elevator.

26. The system of claim 25, wherein the object orientation system is operable to center a frame mounted object based on the outer dimensions of the object.

27. The system of claim 1, further comprising:
a horizontal transportation system for moving a frame mounted object if the object release port is occupied; and
a second port to release departing objects, the second port operable to receive an object from the horizontal transportation system if the first object release port is occupied.

28. The system of claim 1, further comprising a computer coupled to the object receiving port, the computer operable to:
detect a signal indicating that an object has been received; and
determine a route to one of the storage bays.

29. The system of claim 28, wherein determining a route comprises selecting one of a plurality of elevators.

30. The system of claim 28, wherein the computer is further operable to determine how to orient an object for an object release port.

31. The system of claim 28, wherein the computer is further operable to:
detect a signal indicating that a stored object has been requested;
determine the location of the object; and
determine a route to an object release port for the object.

32. The system of claim 28, wherein the computer is also coupled to the elevator, the transfer carriage system, the storage bays, and the object release port, the computer operable to manage the reception, movement, storage, and release of frame mounted objects in the object storage system by controlling the operations of the object receiving port, the elevator, the transfer carriage system, the storage bays, and the object release port.

33. The system of claim 32, wherein the computer is operable to analyze one or more criteria in managing the object storage system.

34. The system of claim 33, wherein the criteria comprise storage time for an object.

35. The system of claim 33, wherein the criteria comprise occupancy density for the storage bays.

36. The system of claim 33, wherein the criteria comprise expended power.

37. The system of claim 32, wherein the computer is also coupled to an object mounting system, an object orientation system, and a horizontal transportation system, the computer operable to manage the reception, movement, storage, and release of frame mounted objects in the object storage system by further controlling the operations of the object mounting system, the object orientation system, and the horizontal transportation system.

38. The system of claim 1, wherein objects comprise vehicles.

39. The system of claim 1, wherein objects comprise containers with integrated object transportation frames.

40. The system of claim 1, wherein the object receiving port comprises the object release port.

41. A method for object storage, the method comprising:
determining whether an object in a multi-level object storage system is to be moved; and
if an object is to be moved, determining a route based on object storage system movements already in progress.

42. The method of claim 41, wherein the movements comprise simultaneous multi-task movements.

43. The method of claim 41, wherein determining a route is further based on object storage system movements waiting to commence.

44. The method of claim 41, wherein determining a route further comprises one or more criteria.

45. The method of claim 44, wherein the criteria comprise routing time.

46. The method of claim 44, wherein the criteria comprise power consumption.

47. The method of claim 44, wherein the criteria comprise occupancy density for storage bays.

48. The method of claim 41, wherein:
determining whether an object is to be moved comprises determining that an object has been received for storage at an object receiving port; and
determining a route comprises determining a route from the object receiving port to an object storage bay.

49. The method of claim 48, wherein determining a route from the object receiving port to an object storage bay comprises:
selecting a bay in a grid-patterned layout of bays and elevators; and
selecting an elevator in the grid-patterned layout.

50. The method of claim 49, wherein selecting a bay comprises analyzing storage bay occupancy.

51. The method of claim 48, further comprising controlling movement of an object from the object receiving port to the selected storage bay.

52. The method of claim 51, wherein controlling movement of an object comprises:
monitoring the position of the object;
moving the object; and
moving a transportation subsystem to receive the object.

53. The method of claim 51, further comprising mounting the object on an object transportation frame.

54. The method of claim 53, wherein mounting the object on an object transportation frame comprises:
expanding the frame to receive wheels on a first object axis; and
contracting the frame to engage the wheels.

55. The method of claim 51, wherein controlling movement of an object comprises moving the object to a preselected elevator.

56. The method of claim 55, wherein moving the object to a preselected elevator comprises moving the object along two different horizontal axes.

57. The method of claim 56, wherein moving the object along two different horizontal axes comprises transferring the object between transportation systems for each axis.

58. The method of claim 51, wherein controlling movement of an object comprises centering the object for at least one horizontal transportation system based on the outer dimensions of the object.

59. The method of claim 51, further comprising:
determining how to orient an object for an object release port; and
reorienting the object in conformance with the determined orientation.

60. The method of claim 51, further comprising decoupling an object support platform of an elevator from the elevator before loading the object.

61. The method of claim 51, further comprising:
determining along which of two horizontal axes to unload the object from an elevator; and
unloading the object from the elevator along the selected axis.

62. The method of claim 51, wherein controlling movement of an object comprises moving the object from an elevator to an entrance of the selected storage bay.

63. The method of claim 62, further comprising horizontally depositing the object in the selected storage bay.

64. The method of claim 48, further comprising:
measuring an object at the object receiving port; and
determining whether the object is acceptable based on the measurements.

65. The method of claim 41, further comprising simultaneously controlling a plurality of transfer carriage systems on an object storage level.

66. The method of claim 41, wherein:
determining whether an object is to be moved comprises determining that an object being stored in a storage bay has been requested; and
determining a route comprises determining a route from the storage bay to an object release port.

67. The method of claim 66, wherein determining a route comprises selecting an elevator in a grid-patterned layout of bays and elevators.

68. The method of claim 66, wherein determining a route comprises analyzing release port occupancy.

69. The method of claim 66, further comprising controlling movement of the object from the storage bay to the object release port.

70. The method of claim 69, wherein controlling movement comprises:
monitoring the position of the object;
moving the object; and
moving a transportation subsystem to receive the object.

71. The method of claim 70, wherein the transportation subsystem comprises a transfer carriage system, and further comprising centering the object on the transfer carriage system based on the outer dimensions of the object.

72. The method of claim 71, wherein controlling movement comprises exchanging the object across an elevator shaft between transfer carriage systems.

73. The method of claim 69, wherein controlling movement comprises loading the object on a preselected elevator.

74. The method of claim 73, further comprising decoupling an object support platform of the elevator from the elevator before loading the object.

75. The method of claim 73, further comprising:
determining along which of two axes to load the object on the elevator; and
loading the object on the elevator along the selected axis.

76. The method of claim 73, further comprising:
determining whether the selected object release port is occupied; and
if the selected object release port is occupied, moving the object to a second object release port.

77. The method of claim 73, further comprising:
determining along which of two axes to unload the object from the elevator; and
unloading the object from the elevator along the selected axis.

78. The method of claim 73, further comprising dismounting the object from an object transportation frame.

79. The method of claim 73, further comprising conveying object transportation frames from the object release port to an object mounting system.

80. The method of claim 41, wherein:
determining whether an object is to be moved comprises determining that a container being stored in a storage bay has been requested; and
determining a route comprises determining a route from the storage bay to an object access location.

81. A system for object storage, the system comprising:
a computer comprising:
memory operable to store data regarding a multi-level object storage system and objects therein; and
a processor operable to:
determine whether an object is to be moved, and
if an object is to be moved, determine a route object based on object storage system movements already in progress.

82. The system of claim 81, wherein the movements comprise simultaneous multi-task movements.

83. The system of claim 81, wherein the processor is operable to analyze object storage system movements waiting to commence to determine a route.

84. The system of claim 81, wherein the processor is operable to analyze one or more criteria to determine a route.

85. The system of claim 84, wherein the criteria comprise routing time.

86. The system of claim 84, wherein the criteria comprise power consumption.

87. The system of claim 84, wherein the criteria comprise occupancy density of storage bays.

88. The system of claim 81, wherein the processor is operable to:
determine that an object has been received for storage at an object receiving port to determine whether an object is to be moved; and
determine a route from an object receiving port to an object storage bay to determine a route.

89. The system of claim 88, wherein, to determine a route from an object receiving port to an object storage bay, the processor is operable to:
select a bay in a grid-patterned layout of bays and elevators; and
select an elevator in the grid-patterned layout.

90. The system of claim 89, wherein the processor is operable to analyze storage bay occupancy to select a bay.

91. The system of claim 88, wherein the processor is further operable to control movement of an object from an object receiving port to a selected storage bay.

92. The system of claim 91, wherein, to control movement of an object, the processor is operable to:
monitor the position of the object;
issue commands to move the object; and
control movement of a transportation subsystem to receive the object.

93. The system of claim 91, wherein the processor is further operable to control mounting of an object on an object transportation frame.

94. The system of claim 93, wherein, to control mounting of an object on an object transportation frame, the processor is operable to control:
expanding the frame to receive wheels on a first object axis; and
contracting the frame to engage the wheels.

95. The system of claim 91, wherein the processor is operable to control movement of an object to a preselected elevator to control movement of an object.

96. The system of claim 95, wherein the processor is operable to control movement of an object along two different horizontal axes to control movement to a preselected elevator.

97. The system of claim 96, wherein the processor is operable to control transfer of an object between transportation systems for two different horizontal axes to control movement along two different horizontal axes.

98. The system of claim 91, wherein the processor is further operable to control centering of an object for at least one horizontal transportation system based on the outer dimensions of the object to control movement of an object.

99. The system of claim 91, wherein the processor is further operable to:
determine how to orient an object for an object release port; and
control reorienting of the object in conformance with the determined orientation.

100. The system of claim 91, wherein the processor is further operable to control decoupling of an elevator object support platform from an elevator before loading an object.

101. The system of claim 91, wherein the processor is further operable to:
determine along which of two horizontal axes to unload an object from an elevator; and
control unloading along the selected axis.

102. The system of claim 91, wherein the processor is operable to control movement of an object from an elevator to an entrance of a selected storage bay to control movement of an object.

103. The system of claim 102, wherein the processor is further operable to control horizontal depositing of the object in the selected storage bay.

104. The system of claim 81, wherein the processor is further operable to simultaneously control a plurality of transfer carriage systems on an object storage level.

105. The system of claim 81, wherein the processor is operable to:
determine that an object being stored in a storage bay has been requested to determine whether an object is to be moved; and
determine a route from a storage bay to an object release port to determine a route.

106. The system of claim 105, wherein the processor is operable to select an elevator in a grid-patterned layout of bays and elevators to determine a route.

107. The system of claim 105, wherein the processor is operable to analyze release port occupancy to determine a route.

108. The system of claim 105, wherein the processor is further operable to control movement of an object from a storage bay to an object release port.

109. The system of claim 108, wherein, to control movement, the processor is operable to:
monitor the position of the object;
issue commands to move the object; and
control movement of a transportation subsystem to receive the object.

110. The system of claim 109, wherein the processor is further operable to control centering of the object on the transportation subsystem based on the outer dimensions of the object.

111. The system of claim 108, wherein the processor is operable to control movement of an object across an elevator shaft to control movement of an object.

112. The system of claim 108, wherein the processor is operable to control loading of an object on a preselected elevator to control movement of an object.

113. The system of claim 108, wherein the processor is further operable to control decoupling of an elevator object support platform from an elevator before loading an object.

114. The system of claim 108, wherein the processor is further operable to:
determine along which of two axes to load an object on an elevator; and
control loading along the selected axis.

115. The system of claim 108, wherein the processor is further operable to:
determine whether a selected object release port is occupied; and
if the selected object release port is occupied, control movement of the object to a second object release port.

116. The system of claim 108, wherein the processor is further operable to:
determine along which of two axes to unload an object from an elevator; and
control unloading along the selected axis.

117. The system of claim 108, wherein the processor is further operable to control dismounting of an object from an object transportation frame.

118. The system of claim 81, wherein the processor is operable to:
determine that a container being stored in a storage bay has been requested to determine whether an object is to be moved; and
determine a route from a storage bay to an object access location to determine a route.

119. An article comprising a machine-readable medium storing instructions operable to cause one or more machines to perform operations comprising:
determining whether an object is to be moved; and
if an object is to be moved, determining a route based on object storage system movements already in progress.

120. The article of claim 119, wherein the movements comprise simultaneous multi-task movements.

121. The article of claim 119, wherein the instructions are operable to cause one or more machines to analyze object storage system movements waiting to commence to determine a route.

122. The article of claim 119, wherein the instructions are operable to cause one or more machines to analyze one or more criteria to determine a route.

123. The article of claim 119, wherein the instructions are operable to cause one or more machines to:
determine that an object has been received for storage at an object receiving port to determine whether an object is to be moved; and
determine a route from an object receiving port to an object storage bay to determine a route.

124. The article of claim 123, wherein, to determine a route from an object receiving port to an object storage bay, the instructions are operable to cause one or more machines to:
select a bay in a grid-patterned layout of bays and elevators; and
select an elevator in the grid-patterned layout.

125. The article of claim 124, wherein the instructions are operable to cause one or more machines to analyze storage bay occupancy to select a bay.

126. The article of claim 124, wherein the instructions are operable to cause one or more machines to move an object from an object receiving port to a selected storage bay.

127. The article of claim 126, wherein, to move an object, the instructions are operable to cause one or more machines to:
monitor the position of the object;
move the object; and
move a transportation subsystem to receive the object.

128. The article of claim 126, wherein the instructions are further operable to cause one or more machines to mount an object on an object transportation frame.

129. The article of claim 128, wherein, to mount an object on an object transportation frame, the instructions are operable to cause one or more machines to:
expand the frame to receive wheels on a first object axis; and
contract the frame to engage the wheels.

130. The article of claim 126, wherein the instructions are operable to cause one or more machines to move an object to a preselected elevator to move an object.

131. The article of claim 130, wherein the instructions are operable to cause one or more machines to move an object along two different horizontal axes to move an object to a preselected elevator.

132. The article of claim 131, wherein the instructions are operable to cause one or more machines to transfer an object between transportation systems for two different horizontal axes to move an object along two different horizontal axes.

133. The article of claim 123, wherein the instructions are further operable to cause one or more machines to center an object for at least one horizontal transportation system based on the outer dimensions of the object.

134. The article of claim 123, wherein the instructions are further operable to cause one or more machines to:
determine how to orient an object for an object release port; and
reorient the object in conformance with the determined orientation.

135. The article of claim 123, wherein the instructions are further operable to cause one or more machines to decouple an elevator object support platform from an elevator before loading an object.

136. The article of claim 123, wherein the instructions are further operable to cause one or more machines to:
determine along which of two horizontal axes to unload an object from an elevator; and
unload along the selected axis.

137. The article of claim 123, wherein the instructions are further operable to cause one or more machines to move an object from an elevator to an entrance of a selected storage bay.

138. The article of claim 137, wherein the instructions are further operable to cause one or more machines to horizontally deposit an object in a selected storage bay.

139. The article of claim 119, wherein the instructions are operable to cause one or more machines to:
determine that an object being stored in a storage bay has been requested to determine whether an object is to be moved; and
determine a route from a storage bay to an object release port to determine a route.

140. The article of claim 139, wherein the instructions are operable to cause one or more machines to select an elevator in a grid-patterned layout of bays and elevators to determine a route.

141. The article of claim 139, wherein the instructions are operable to cause one or more machines to analyze release port occupancy to determine a route.

142. The article of claim 139, wherein the instructions are further operable to cause one or more machines to move an object from a storage bay to an object release port.

143. The article of claim 142, wherein, to move an object, the instructions are operable to cause one or more machines to:
monitor the position of the object;
move the object; and
move a transportation subsystem to receive the object.

144. The article of claim 143, wherein the instructions are operable to cause one or more machines to center the object on the transportation subsystem based on the outer dimensions of the object.

145. The article of claim 142, wherein the instructions are operable to cause one or more machines to move an object across an elevator shaft to move an object.

146. The article of claim 142, wherein the instructions are operable to cause one or more machines to load an object on a preselected elevator to move an object.

147. The article of claim 142, wherein the instructions are further operable to cause one or more machines to decouple an elevator object support platform from an elevator before loading an object.

148. The article of claim 142, wherein the instructions are further operable to cause one or more machines to:
determine along which of two axes to load an object on an elevator; and
load along the selected axis.

149. The article of claim 142, wherein the instructions are further operable to cause one or more machines to:
determine whether a selected object release port is occupied; and
if the selected object release port is occupied, move the object to a second object release port.

150. The article of claim 142, wherein the instructions are further operable to cause one or more machines to:
determine along which of two axes to unload an object from an elevator; and
unload along the selected axis.

151. The article of claim 142, wherein the instructions are further operable to cause one or more machines to dismount an object from an object transportation frame.

152. The article of claim 119, wherein the instructions are further operable to cause one or more machines to:
determine that a container being stored in a storage bay has been requested to determine whether an object is to be moved; and
determine a route from a storage bay to an object access location to determine a route.

153. An object storage system, the object storage system comprising:
an object transportation frame comprising:
two parallel outer frame members, the outer frame members operable to engage wheels on an axis of an object; and
a telescopic device coupled between the outer frame members, the telescopic device operable to allow the outer frame members to controllably expand relative to each other.

154. The system of claim 153, wherein the telescopic device comprises:
two arms, one arm coupled to one of the outer frame members, the other arm coupled to the other outer frame member; and
a locking housing coupled to the arms, the locking housing operable to allow the arms to controllably extend.

155. The system of claim 154, wherein:
the arms comprise teeth; and
the locking housing comprises a detent that controllably meshes with the teeth.

156. The system of claim 153, wherein the object transportation frame comprises movement devices to allow movement of the frame along two horizontal axes.

157. The system of claim 156, wherein the first horizontal axis and the second horizontal axis are orthogonal to each other

158. The system of claim 156, wherein the movement devices comprise:
rollers for facilitating movement along the first horizontal axis; and
rollers for facilitating movement along the second horizontal axis.

159. The system of claim 158, wherein the rollers are connected to the outer frame members.

160. The system of claim 156, wherein the movement devices comprise:
a sprocket chain for facilitating movement along the first horizontal axis; and
a sprocket chain for facilitating movement along the second horizontal axis.

161. The system of claim 160, wherein the sprocket chains are connected to the outer frame members.

162. The system of claim 153, wherein the outer frame members are adapted to support the wheels of an object.

163. The system of claim 153, wherein the axis comprises an axle of a vehicle.
